(19) United States
(12) Patent Application Publication
(10) Pub. No.: US 2020/0001333 A1
(43) Pub. Date: Jan. 2, 2020

(54) SUBSTRATE PROCESSING METHOD AND SUBSTRATE PROCESSING APPARATUS

(71) Applicant: SCREEN Holdings Co., Ltd., Kyoto (JP)

(72) Inventors: Masayuki OTSUJI, Kyoto (JP); Hiroaki TAKAHASHI, Kyoto (JP); Masahiko KATO, Kyoto (JP); Naozumi FUJIWARA, Kyoto (JP); Yu YAMAGUCHI, Kyoto (JP); Yuta SASAKI, Kyoto (JP)

(21) Appl. No.: 16/456,016

(22) Filed: Jun. 28, 2019

(30) Foreign Application Priority Data
Jun. 29, 2018 (JP) 2018-124746

(51) Int. Cl. B08B 7/04; B08B 7/00; B08B 5/02; B08B 3/04

(52) U.S. Cl. CPC B08B 7/04; B08B 7/0014; B08B 3/041; B08B 7/0071; B08B 5/023; B08B 7/0092

(57) ABSTRACT

The present substrate processing method includes a pre-drying processing liquid supplying step of supplying, to a front surface of a substrate, a pre-drying processing liquid, having a freezing point lower than a freezing point of the solidified body forming substance, a solidified body forming step of solidifying a portion of the pre-drying processing liquid on the front surface of the substrate to form the solidified body, containing the solidified body forming substance, inside the pre-drying processing liquid, a liquid removing step of removing the pre-drying processing liquid on the front surface of the substrate while letting the solidified body remain on the front surface of the substrate, and a solid removing step of removing the solidified body, remaining on the front surface of the substrate, from the front surface of the substrate by making the solidified body change to a gas.

### CROSS REFERENCE TO RELATED APPLICATION

The present application corresponds to Japanese Patent Application No. 2018-124746 filed on Jun. 29, 2018 in the Japan Patent Office, and the entire disclosure of this application is incorporated herein by reference.

### BACKGROUND OF THE INVENTION

### 1. Field of the Invention

The present invention relates to a substrate processing method and a substrate processing apparatus for processing substrates. Examples of substrates to be processed include semiconductor wafers, substrates for liquid crystal displays, substrates for optical disks, substrates for magnetic disks, substrates for magneto-optical disks, substrates for photomasks, ceramic substrates, substrates for solar cells, substrates for organic EL (electroluminescence) displays and other FPDs (flat panel displays), etc.

### 2. Description of Related Art

In a manufacturing process of a semiconductor device or a liquid crystal display, etc., processing according to needs is performed on a substrate, such as a semiconductor wafer or a glass substrate for liquid crystal display, etc. Such processing includes supplying of a processing liquid, such as a chemical liquid or a rinse liquid, etc., to the substrate. After the processing liquid is supplied, the processing liquid is removed from the substrate and the substrate is dried.

If a pattern is formed on a front surface of the substrate, a force due to surface tension of the processing liquid attached to the substrate maybe applied to the pattern and cause the pattern to collapse when the substrate is dried. As a countermeasure for this, a method of supplying a liquid of low surface tension, such as IPA (isopropyl alcohol), etc., to the substrate or supplying a hydrophobizing agent, which makes a contact angle of a liquid with respect to the pattern approach 90 degrees, to the substrate is adopted. However, even when IPA or a hydrophobizing agent is used, a collapsing force that collapses the pattern does not become zero and therefore, depending on a strength of the pattern, it may not be possible to sufficiently prevent pattern collapse even when these countermeasures are taken.

In recent years, sublimation drying has come to be noted as art for preventing pattern collapse. For example, a substrate processing method and a substrate processing apparatus with which sublimation drying is performed are disclosed in Japanese Patent Application Publication No. 2015-142069. With the sublimation drying described in Japanese Patent Application Publication No. 2015-142069, a melt of a sublimable substance is supplied to a front surface of a substrate and DIW on the substrate is replaced by the melt of the sublimable substance. Thereafter, the sublimable substance on the substrate is made to solidify. Thereafter, a solidified body of the sublimable substance on the substrate is sublimated. The melt of the sublimable substance is thereby removed from the substrate and the substrate is dried. In Japanese Patent Application Publication No. 2015-142069, tert-butyl alcohol is cited as a specific example of the sublimable substance. According to the description in Japanese Patent Application Publication No. 2015-142069, a freezing point of tert-butyl alcohol is 25° C.

### SUMMARY OF THE INVENTION

As mentioned above, with Japanese Patent Application Publication No. 2015-142069, the melt of the sublimable substance is supplied to the substrate. If room temperature is, for example, 23° C., the freezing point of tert-butyl alcohol, which is one of the specific examples of the sublimable substance, is higher than room temperature. Therefore, if the substrate processing apparatus is disposed in a space at room temperature, the sublimable substance must be heated to maintain the sublimable substance as a liquid.

It is described in Japanese Patent Application Publication No. 2015-142069 that an interior of a storage tank storing a liquid of tert-butyl alcohol is maintained at a temperature higher than the freezing point of tert-butyl alcohol. The substrate processing apparatus described in Japanese Patent Application Publication No. 2015-142069 is thus considered to be disposed in the space at room temperature and the interior of the storage tank is heated by a heater. Energy for making the heater generate heat is thus required.

An object of the present invention is thus to provide a substrate processing method and a substrate processing apparatus capable of decreasing a rate of pattern collapse that occurs during drying of a substrate while decreasing an energy consumption amount required for processing the substrate.

The present invention provides a substrate processing method including a pre-drying processing liquid supplying step of supplying, to a front surface of a substrate, a pre-drying processing liquid, containing a solidified body forming substance, which is a substance for forming a solidified body, and a dissolution substance, which blends together with the solidified body forming substance, and having a freezing point lower than a freezing point of the solidified body forming substance, a solidified body forming step of solidifying a portion of the pre-drying processing liquid on the front surface of the substrate to form the solidified body, containing the solidified body forming substance, inside the pre-drying processing liquid, a liquid removing step of removing the pre-drying processing liquid on the front surface of the substrate while letting the solidified body remain on the front surface of the substrate, and a solid removing step of removing the solidified body, remaining on the front surface of the substrate, from the front surface of the substrate by making the solidified body change to a gas.

According to this method, instead of supplying a melt of the solidified body forming substance to the front surface of the substrate, the pre-drying processing liquid that contains the solidified body forming substance is supplied to the front surface of the substrate. The pre-drying processing liquid contains the solidified body forming substance that is a substance for forming the solidified body and the dissolution substance that blends together with the solidified body forming substance. That is, the solidified body forming substance and the dissolution substance are mutually blended together and the freezing point of the pre-drying processing liquid is thereby lowered. The freezing point of the pre-drying processing liquid is lower than the freezing point of the solidified body forming substance.

If the pre-drying processing liquid is a liquid at ordinary temperature and ordinary pressure, that is, if the freezing point of the pre-drying processing liquid is lower than room temperature (for example 23° C. or a value in a vicinity thereof) at ordinary pressure (pressure inside a substrate processing apparatus, for example, 1 atmosphere or a value in a vicinity thereof), the pre-drying processing liquid does not have to be heated to maintain the pre-drying processing liquid as a liquid. A heater that heats the pre-drying processing liquid thus does not have to be provided. Even if the freezing point of the pre-drying processing liquid is not lower than room temperature at ordinary pressure and heating of the pre-drying processing liquid is necessary to maintain the pre-drying processing liquid as a liquid, an applied heat amount can be decreased in comparison to a case of using the melt of the solidified body forming substance. An energy consumption amount can thereby be decreased.

After the pre-drying processing liquid is supplied to the front surface of the substrate, a portion of the pre-drying processing liquid on the front surface of the substrate is solidified. The solidified body, containing the solidified body forming substance, is thereby formed inside the pre-drying processing liquid. Thereafter, the remaining pre-drying processing liquid is removed from the front surface of the substrate. The solidified body thereby remains on the front surface of the substrate. The solidified body is then changed to a gas. The solidified body is thereby eliminated from the front surface of the substrate. Therefore, even when a fragile pattern is formed on the front surface of the substrate, the substrate can be dried while suppressing pattern collapse because the substrate is dried without forming a liquid surface between two mutually adjacent patterns.

If the pre-drying processing liquid is a solution in which a solute and a solvent are blended together uniformly, one of the solidified body forming substance and the dissolution substance may be the solute and the other of the solidified body forming substance and the dissolution substance may be the solvent. Both the solidified body forming substance and the dissolution substance may be solutes. That is, a solvent that blends together with the solidified body forming substance and the dissolution substance may be contained in the pre-drying processing liquid. In this case, a vapor pressure of the solvent may be equal to or may differ from a vapor pressure of the solidified body forming substance. Similarly, the vapor pressure of the solvent may be equal to or may differ from a vapor pressure of the dissolution substance.

The solidified body forming substance may be a sublimable substance that changes from a solid to a gas without transition to a liquid at ordinary temperature or ordinary pressure or may be a substance other than a sublimable substance. Similarly, the dissolution substance may be a sublimable substance or may be a substance other than a sublimable substance. For example, the solidified body forming substance may be a sublimable substance and the dissolution substance may be a sublimable substance of a type differing from the solidified body forming substance.

The sublimable substance may be a substance that sublimates at room temperature (for example, 22 to 25° C.) when depressurization to a value lower than ordinary pressure is performed. In this case, the solidified body can be sublimated by a comparatively easy method of depressurizing an atmosphere in contact with the solidified body. Or, the sublimable substance may be a substance that sublimates at ordinary pressure when heated to a temperature higher than room temperature. In this case, the solidified body can be sublimated by a comparatively easy method of heating the solidified body.

In a preferred embodiment of the present invention, the solidified body forming step includes a cooling step of cooling the pre-drying processing liquid on the front surface of the substrate.

According to this method, the pre-drying processing liquid on the front surface of the substrate is cooled. When a saturation concentration of the solidified body forming substance in the pre-drying processing liquid falls below a concentration of the solidified body forming substance in the pre-drying processing liquid, crystals containing the solidified body forming substance precipitate. The solidified body containing the solidified body forming substance can thereby be formed inside the pre-drying processing liquid. If a cooling temperature of the pre-drying processing liquid is lower than the freezing point of the pre-drying processing liquid, the frozen body is formed inside the pre-drying processing liquid by solidifying of the pre-drying processing liquid. The solid containing the solidified body forming substance can thereby be formed inside the pre-drying processing liquid.

The cooling temperature of the pre-drying processing liquid may be a temperature lower than room temperature and not higher than the freezing point of the pre-drying processing liquid or may be temperature lower than room temperature and higher than the freezing point of the pre-drying processing liquid.

In a preferred embodiment of the present invention, the cooling step includes a precipitating step of cooling the pre-drying processing liquid on the front surface of the substrate to decrease the saturation concentration of the solidified body forming substance in the pre-drying processing liquid on the front surface of the substrate to a value lower than a concentration of the solidified body forming substance in the pre-drying processing liquid on the front surface of the substrate.

According to this method, the pre-drying processing liquid on the front surface of the substrate is cooled to decrease the saturation concentration of the solidified body forming substance in the pre-drying processing liquid. When the saturation concentration of the solidified body forming substance falls below the concentration of the solidified body forming substance, crystals of the solidified body forming substance or crystals having the solidified body forming substance as a main component precipitate. The solidified body that is high in purity of the solidified body forming substance can thereby be formed inside the pre-drying processing liquid and the solidified body that is high in purity of the solidified body forming substance can be left to remain on the front surface of the substrate.

In a preferred embodiment of the present invention, the method further includes a preheating step of making a portion of the pre-drying processing liquid on the front surface of the substrate evaporate by heating before the pre-drying processing liquid on the front surface of the substrate is cooled.

According to this method, the pre-drying processing liquid on the front surface of the substrate is heated. A portion of the pre-drying processing liquid thereby evaporates and the pre-drying processing liquid on the substrate decreases. Thereafter, the pre-drying processing liquid on the front surface of the substrate is cooled to decrease the saturation concentration of the solidified body forming substance. The solidified body can be formed in a short time in comparison to a case where the pre-drying processing liquid is not heated because the pre-drying processing liquid on the substrate is decreased by the preheating of the pre-drying processing liquid.

The preheating step may include at least one of a heating gas supplying step of discharging a heating gas of higher temperature than the pre-drying processing liquid on the front surface of the substrate toward at least one of the front surface and a rear surface of the substrate, a heating liquid supplying step of discharging a heating liquid of higher temperature than the pre-drying processing liquid on the front surface of the substrate toward the rear surface of the substrate, a proximity heating step of disposing a heating member of higher temperature than the pre-drying processing liquid on the front surface of the substrate at a front surface side or the rear surface side of the substrate while separating the heating member from the substrate, a contact heating step of making a heating member of higher temperature than the pre-drying processing liquid on the front surface of the substrate contact the rear surface of the substrate, and a light irradiating step of irradiating light onto the pre-drying processing liquid on the front surface of the substrate. The light irradiating step may include an overall irradiating step of irradiating light toward an entirety of the front surface of the substrate simultaneously or a partial irradiating step of irradiating light toward just an irradiation region that represents a region of a portion within the front surface of the substrate and meanwhile moving the irradiation region within the front surface of the substrate or may include both the overall irradiating step and the partial irradiating step.

In a preferred embodiment of the present invention, the vapor pressure of the dissolution substance is higher than the vapor pressure of the solidified body forming substance.

According to this method, the vapor pressure of the dissolution substance contained in the pre-drying processing liquid is higher than the vapor pressure of the solidified body forming substance contained in the pre-drying processing liquid. Therefore, when the pre-drying processing liquid is heated before cooling, the dissolution substance evaporates at an evaporation rate (evaporation amount per unit time) higher than an evaporation rate of the solidified body forming substance. The concentration of the solidified body forming substance in the pre-drying processing liquid can thereby be increased. The solidified body can thus be formed in a short time in comparison to a case where the pre-drying processing liquid is not heated.

In a preferred embodiment of the present invention, the concentration of the solidified body forming substance in the pre-drying processing liquid is not less than a eutectic point concentration of the solidified body forming substance and the dissolution substance in the pre-drying processing liquid, and the cooling step includes a solidifying step of cooling the pre-drying processing liquid on the front surface of the substrate to not higher than the freezing point of the pre-drying processing liquid.

According to this method, the pre-drying processing liquid on the front surface of the substrate is cooled to not higher than the freezing point of the pre-drying processing liquid. A portion of the pre-drying processing liquid thereby solidifies and the solidified body gradually becomes larger. The concentration of the solidified body forming substance is not less than the eutectic point concentration of the solidified body forming substance and the dissolution substance and therefore when the solidifying of the pre-drying processing liquid begins, the solidified body of the solidified body forming substance or the solidified body having the solidified body forming substance as a main component is formed inside the pre-drying processing liquid. The solidified body that is high in purity of the solidified body forming substance can thereby be formed inside the pre-drying processing liquid.

On the other hand, when the solidifying of the solidified body forming substance progresses due to the cooling of the pre-drying processing liquid, the concentration of the solidified body forming substance in the pre-drying processing liquid gradually decreases. In other words, the concentration of the dissolution substance in the pre-drying processing liquid gradually increases. The pre-drying processing liquid that is increased in the concentration of the dissolution substance is then removed from the substrate and the solidified body that is high in purity of the solidified body forming substance remains on the substrate. The solidified body forming substance contained in the pre-drying processing liquid can thus be used efficiently.

The eutectic point concentration of the solidified body forming substance and the dissolution substance in the pre-drying processing liquid is a concentration at which crystals of both the solidified body forming substance and the dissolution substance precipitate from the pre-drying processing liquid when the pre-drying processing liquid is cooled to not higher than the freezing point of the pre-drying processing liquid.

In a preferred embodiment of the present invention, the cooling step includes an indirect cooling step of cooling the pre-drying processing liquid on the front surface of the substrate via the substrate to form the solidified body in a bottom layer, which, in the pre-drying processing liquid, contacts the front surface of the substrate. The liquid removing step includes a step of removing the pre-drying processing liquid on the solidified body while letting the solidified body remain on the front surface of the substrate.

According to this method, the pre-drying processing liquid on the front surface of the substrate is cooled indirectly by cooling the substrate instead of cooling the pre-drying processing liquid on the front surface of the substrate directly. The bottom layer, which, in the pre-drying processing liquid on the front surface of the substrate, contacts the front surface of the substrate (which, if a pattern is formed, includes a front surface of the pattern), is thus cooled efficiently and the solidified body is formed at an interface between the pre-drying processing liquid and the substrate. Excess pre-drying processing liquid remains on the solidified body. Therefore, by removing the pre-drying processing liquid from top of the solidified body, the pre-drying processing liquid can be removed from the front surface of the substrate while letting the solidified body remain on the front surface of the substrate.

In a preferred embodiment of the present invention, the indirect cooling step includes a cooling fluid supplying step of supplying, to the rear surface of the substrate, a cooling fluid, which is a fluid of lower temperature than the pre-drying processing liquid on the front surface of the substrate, in a state where the pre-drying processing liquid is on the front surface of the substrate.

According to this method, the cooling fluid, which is at least one of a gas and a liquid of lower temperature than the pre-drying processing liquid on the front surface of the substrate, is made to contact the rear surface of the substrate. The pre-drying processing liquid on the front surface of the substrate can thereby be cooled indirectly.

In a preferred embodiment of the present invention, the indirect cooling step includes a cooling member disposing step of disposing, at the rear surface side of the substrate, a cooling member of lower temperature than the pre-drying processing liquid on the front surface of the substrate.

According to this method, the cooling member of lower temperature than the pre-drying processing liquid on the front surface of the substrate is disposed at the rear surface side of the substrate, which is a flat surface opposite the front surface of the substrate. If the cooling member is made to contact the rear surface of the substrate, the substrate is cooled directly by the cooling member. If the cooling member is put in proximity to the rear surface of the substrate without letting it contact the rear surface of the substrate, the substrate is cooled indirectly by the cooling member. Therefore, in either case, the pre-drying processing liquid on the front surface of the substrate can be cooled indirectly without making a fluid contact the substrate.

The cooling step may include, in addition to or in place of the indirect cooling step, at least one of a cooling gas supplying step of discharging a cooling gas of lower temperature than the pre-drying processing liquid on the front surface of the substrate toward the pre-drying processing liquid on the front surface of the substrate, a precooling step of cooling the substrate before the pre-drying processing liquid is supplied to the front surface of the substrate, a vaporization cooling step of discharging a low humidity gas, with a humidity lower than a humidity of an atmosphere in contact with the pre-drying processing liquid on the front surface of the substrate, toward the pre-drying processing liquid on the front surface of the substrate to make the pre-drying processing liquid evaporate and take away heat of vaporization from the pre-drying processing liquid, and a melting cooling step of making the pre-drying processing liquid melt the solidified body forming substance to take heat of melting from the pre-drying processing liquid on the front surface of the substrate.

If the cooling step includes the vaporization cooling step, the low humidity gas may be an inert gas, clean air (air filtered by a filter), or dry air (dehumidified clean air), or a gas other than these. Nitrogen gas, which is an example of an inert gas, is a gas with a humidity of, for example, not more than 10%, and clean air is a gas with a humidity of, for example, not more than 40%. A humidity of dry air is lower than the humidity of clean air.

In a preferred embodiment of the present invention, the liquid removing step includes a substrate rotating/holding step of rotating the substrate around a vertical rotational axis while holding it horizontally to remove the pre-drying processing liquid on the front surface of the substrate while letting the solidified body remain on the front surface of the substrate.

According to this method, after the solidified body is formed inside the pre-drying processing liquid, the substrate is rotated around the vertical rotational axis while being held horizontally. The pre-drying processing liquid on the substrate is expelled from the substrate by a centrifugal force. The excess pre-drying processing liquid can thereby be removed from the front surface of the substrate while letting the solidified body remain on the front surface of the substrate.

In a preferred embodiment of the present invention, the liquid removing step includes a gas supplying step of discharging a gas toward the front surface of the substrate to remove the pre-drying processing liquid on the front surface of the substrate while letting the solidified body remain on the front surface of the substrate.

According to this method, the gas is blown onto the front surface of the substrate after the solidified body is formed inside the pre-drying processing liquid. The pre-drying processing liquid on the substrate is expelled from the substrate by a pressure of the gas. The excess pre-drying processing liquid can thereby be removed from the front surface of the substrate while letting the solidified body remain on the front surface of the substrate.

In a preferred embodiment of the present invention, the liquid removing step includes an evaporating step of making the pre-drying processing liquid on the front surface of the substrate evaporate by heating to remove the pre-drying processing liquid on the front surface of the substrate while letting the solidified body remain on the front surface of the substrate.

According to this method, the pre-drying processing liquid on the front surface of the substrate is heated after the solidified body is formed inside the pre-drying processing liquid. The pre-drying processing liquid thereby evaporates and is drawn off from the substrate. The excess pre-drying processing liquid can thus be removed from the front surface of the substrate while letting the solidified body remain on the front surface of the substrate.

The liquid removing step may include, in addition to or in place of at least one of the substrate rotating/holding step, the gas supplying step, and the evaporating step, at least one of a depressurizing step of decreasing a pressure of an atmosphere in contact with the pre-drying processing liquid on the front surface of the substrate, a light irradiating step of irradiating light onto the pre-drying processing liquid on the front surface of the substrate, and an ultrasonic vibration applying step of applying ultrasonic vibration to the pre-drying processing liquid on the front surface of the substrate.

In a preferred embodiment of the present invention, the freezing point of the solidified body forming substance is not lower than room temperature and the freezing point of the pre-drying processing liquid is lower than room temperature. Also, the pre-drying processing liquid supplying step includes a step of supplying the pre-drying processing liquid of room temperature to the front surface of the substrate.

According to this method, the pre-drying processing liquid of room temperature is supplied to the substrate. Whereas the freezing point of the solidified body forming substance is not lower than room temperature, the freezing point of the pre-drying processing liquid is lower than room temperature. If the melt of the solidified body forming substance is supplied to the substrate, the solidified body forming substance must be heated to maintain the solidified body forming substance as a liquid. On the other hand, if the pre-drying processing liquid is supplied to the substrate, the pre-drying processing liquid can be maintained as a liquid even without heating the pre-drying processing liquid. The energy consumption amount required for processing the substrate can thereby be decreased.

In a preferred embodiment of the present invention, the method further includes a film thickness decreasing step of rotating the substrate around a vertical rotational axis while holding it horizontally before the solidified body is formed to remove a portion of the pre-drying processing liquid on the front surface of the substrate by a centrifugal force and decrease a film thickness of the pre-drying processing liquid.

According to this method, before the solidified body is formed inside the pre-drying processing liquid, the substrate is rotated around the vertical rotational axis while being held horizontally. A portion of the pre-drying processing liquid on the front surface of the substrate is removed from the substrate by the centrifugal force. The film thickness of the pre-drying processing liquid is thereby decreased. The solidified body is formed thereafter. The solidified body can be formed in a short time and the solidified body can be made thin because the film thickness of the pre-drying processing liquid is decreased. Time required for forming the solidified body and time required for vaporization of the solidified body can thus be shortened. The energy consumption amount required for processing the substrate can thereby be decreased.

The solid removing step may include at least one of a sublimating step of making the solidified body sublimate from a solid to a gas, a decomposition step of making the solidified body change to a gas, without transition to a liquid, by decomposition (for example, thermal decomposition) of the solidified body, and a reaction step of making the solidified body change to a gas, without transition to a liquid, by a reaction (for example, an oxidation reaction) of the solidified body.

The sublimating step may include at least one of a substrate rotating/holding step of rotating the substrate around a vertical rotational axis while holding it horizontally, a gas supplying step of blowing a gas onto the solidified body, a heating step of heating the solidified body, a depressurizing step of decreasing a pressure of an atmosphere in contact with the solidified body, a light irradiating step of irradiating light onto the solidified body, and an ultrasonic vibration applying step of applying ultrasonic vibration to the solidified body.

In a preferred embodiment of the present invention, the method further includes a substrate transfer step of transferring the substrate, with the solidified body remaining on the front surface of the substrate, from a first chamber, in which the liquid removing step is performed, to a second chamber, in which the solid removing step is performed.

According to this method, when the substrate is disposed inside the first chamber, the pre-drying processing liquid on the front surface of the substrate is removed while letting the solidified body remain on the front surface of the substrate. Thereafter, the substrate is transferred from the first chamber to the second chamber. Then, when the substrate is disposed inside the second chamber, the solidified body remaining on the front surface of the substrate is vaporized. The removing of the pre-drying processing liquid and the removing of the solidified body are thus performed in separate chambers and therefore structures inside the first chamber and the second chamber can be simplified and each individual chamber can be made compact.

The present invention is a substrate processing apparatus including a pre-drying processing liquid supplying means, supplying, to a front surface of a substrate, a pre-drying processing liquid, containing a solidified body forming substance, which is a substance for forming a solidified body, and a dissolution substance, which blends together with the solidified body forming substance, and having a freezing point lower than a freezing point of the solidified body forming substance, a solidified body forming means, solidifying a portion of the pre-drying processing liquid on the front surface of the substrate to form the solidified body, containing the solidified body forming substance, inside the pre-drying processing liquid, a liquid removing means, removing the pre-drying processing liquid on the front surface of the substrate while letting the solidified body remain on the front surface of the substrate, and a solid removing means, removing the solidified body, remaining on the front surface of the substrate, from the front surface of the substrate by making the solidified body change to a gas.

According to this configuration, instead of supplying a melt of the solidified body forming substance to the front surface of the substrate, the pre-drying processing liquid that contains the solidified body forming substance is supplied to the front surface of the substrate. The pre-drying processing liquid contains the solidified body forming substance that is a substance for forming the solidified body and the dissolution substance that blends together with the solidified body forming substance. That is, the solidified body forming substance and the dissolution substance are mutually blended together and the freezing point of the pre-drying processing liquid is thereby lowered. The freezing point of the pre-drying processing liquid is lower than the freezing point of the solidified body forming substance.

If the pre-drying processing liquid is a liquid at ordinary temperature and ordinary pressure, that is, if the freezing point of the pre-drying processing liquid is lower than room temperature (for example 23° C. or a value in a vicinity thereof) at ordinary pressure (pressure inside the substrate processing apparatus; for example, 1 atmosphere or a value in a vicinity thereof), the pre-drying processing liquid does not have to be heated to maintain the pre-drying processing liquid as a liquid. A heater that heats the pre-drying processing liquid thus does not have to be provided. Even if the freezing point of the pre-drying processing liquid is not lower than room temperature at ordinary pressure and heating of the pre-drying processing liquid is necessary to maintain the pre-drying processing liquid as a liquid, an applied heat amount can be decreased in comparison to a case of using the melt of the solidified body forming substance. An energy consumption amount can thereby be decreased.

After the pre-drying processing liquid is supplied to the front surface of the substrate, a portion of the pre-drying processing liquid on the front surface of the substrate is solidified. The solidified body, containing the solidified body forming substance, is thereby formed inside the pre-drying processing liquid. Thereafter, the remaining pre-drying processing liquid is removed from the front surface of the substrate. The solidified body thereby remains on the front surface of the substrate. The solidified body is then changed to a gas. The solidified body is thereby eliminated from the front surface of the substrate. Therefore, even when a fragile pattern is formed on the front surface of the substrate, the substrate can be dried while suppressing pattern collapse because the substrate is dried without forming a liquid surface between two mutually adjacent patterns.

If the pre-drying processing liquid is a solution in which a solute and a solvent are blended together uniformly, one of the solidified body forming substance and the dissolution substance may be the solute and the other of the solidified body forming substance and the dissolution substance may be the solvent. Both the solidified body forming substance and the dissolution substance may be solutes. That is, a solvent that blends together with the solidified body forming substance and the dissolution substance may be contained in the pre-drying processing liquid. In this case, a vapor pressure of the solvent may be equal to or may differ from a vapor pressure of the solidified body forming substance. Similarly, the vapor pressure of the solvent may be equal to or may differ from a vapor pressure of the dissolution substance.

The solidified body forming substance may be a sublimable substance that changes from a solid to a gas without transition to a liquid at ordinary temperature or ordinary pressure or may be a substance other than a sublimable substance. Similarly, the dissolution substance may be a sublimable substance or may be a substance other than a sublimable substance. For example, the solidified body forming substance may be a sublimable substance and the dissolution substance may be a sublimable substance of a type differing from the solidified body forming substance.

The sublimable substance may be a substance that sublimates at room temperature (for example, 22 to 25° C.) when depressurization to a value lower than ordinary pressure is performed. In this case, the solidified body can be sublimated by a comparatively easy method of depressurizing an atmosphere in contact with the solidified body. Or, the sublimable substance may be a substance that sublimates at ordinary pressure when heated to a temperature higher than room temperature. In this case, the solidified body can be sublimated by a comparatively easy method of heating the solidified body.

The aforementioned or yet other objects, features, and effects of the present invention will be clarified by the following description of preferred embodiments with reference to the accompanying drawings.

### BRIEF DESCRIPTION OF THE DRAWINGS

FIG. 1A is a schematic view as viewed from above of a substrate processing apparatus according to a first preferred embodiment of the present invention.

FIG. 1B is a schematic view as viewed from a side of the substrate processing apparatus.

FIG. 2 is a schematic view as viewed horizontally of an interior of a processing unit included in the substrate processing apparatus.

FIG. 3 is a block diagram showing hardware of a controller.

FIG. 4 is a process flowchart for describing an example (first processing example) of processing of a substrate performed by the substrate processing apparatus.

FIG. 5A is a schematic view showing a state of the substrate when the processing of the substrate shown in FIG. 4 is being performed.

FIG. 5B is a schematic view showing a state of the substrate when the processing of the substrate shown in FIG. 4 is being performed.

FIG. 5C is a schematic view showing a state of the substrate when the processing of the substrate shown in FIG. 4 is being performed.

FIG. 5D is a schematic view showing a state of the substrate when the processing of the substrate shown in FIG. 4 is being performed.

FIG. 6 is a graph showing an image of how a concentration and a saturation concentration of a solidified body forming substance in a pre-drying processing liquid change.

FIG. 7 is a process flowchart for describing another example (second processing example) of processing of a substrate performed by the substrate processing apparatus.

FIG. 8A is a schematic view showing a state of the substrate when the processing of the substrate shown in FIG. 7 is being performed.

FIG. 8B is a schematic view showing a state of the substrate when the processing of the substrate shown in FIG. 7 is being performed.

FIG. 8C is a schematic view showing a state of the substrate when the processing of the substrate shown in FIG. 7 is being performed.

FIG. 9 is a graph showing an image of how a freezing point and a temperature of the pre-drying processing liquid on the substrate change.

FIG. 10 is a schematic view as viewed horizontally of a spin chuck and a blocking member according to a second preferred embodiment of the present invention.

FIG. 11A is a schematic view showing a state of the substrate when the pre-drying processing liquid on the substrate is heated by a built-in heater.

FIG. 11B is a schematic view showing a state of the substrate when the pre-drying processing liquid on the substrate is cooled by a cooling plate.

FIG. 12 is a schematic view for describing transfer of the substrate from a wet processing unit, which removes excess pre-drying processing liquid, to a dry processing unit, which changes a solidified body to a gas without transition to a liquid.

### DETAILED DESCRIPTION OF PREFERRED EMBODIMENTS

In the following description, it shall be deemed that, unless notified otherwise, an atmospheric pressure inside a substrate processing apparatus 1 is maintained at an atmospheric pressure (of, for example, 1 atmosphere or a value in a vicinity thereof) inside a clean room in which the substrate processing apparatus 1 is installed.

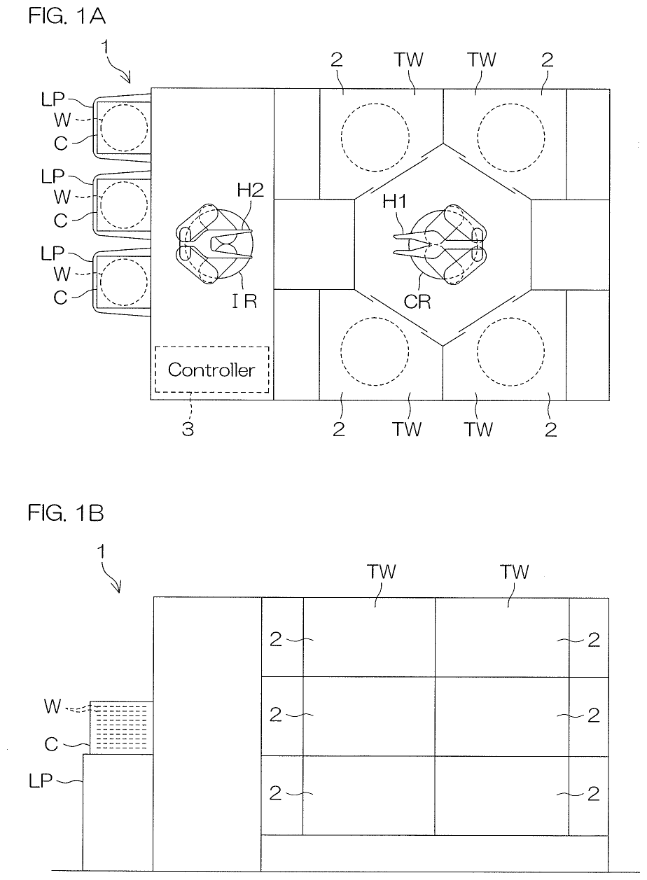

FIG. 1A is a schematic view as viewed from above of the substrate processing apparatus 1 according to a first preferred embodiment of the present invention. FIG. 1B is a schematic view as viewed from a side of the substrate processing apparatus 1.

As shown in FIG. 1A, the substrate processing apparatus 1 is a single substrate processing type apparatus that processes disk-shaped substrates W, such as semiconductor wafers, etc., one by one. The substrate processing apparatus 1 includes load ports LP, holding carriers C that house substrates W, a plurality of processing units 2, processing the substrates W transferred from the carriers C on the load ports LP with processing fluids, such as processing liquids, processing gases, etc., transfer robots, transferring the substrates W between the carriers C on the load ports LP and the processing units 2, and a controller 3, controlling the substrate processing apparatus 1.

The transfer robots include an indexer robot IR, performing carry-in and carry-out of the substrates W with respect to the carriers C on the load ports LP, and a center robot CR, performing carry-in and carry-out of the substrates W with respect to the plurality of processing units 2. The indexer robot IR transfers the substrates W between the load ports LP and the center robot CR, and the center robot CR transfers the substrates W between the indexer robot IR and the processing units 2. The center robot CR includes a hand H1 that supports a substrate W and the indexer robot IR includes a hand H2 that supports a substrate W.

The plurality of processing units 2 form a plurality of towers TW disposed around the center robot CR in plan view. FIG. 1A shows an example where four towers TW are formed. The center robot CR can access any of the towers TW. As shown in FIG. 1B, each tower TW includes a plurality (for example, three) of processing units 2 that are stacked one above the other.

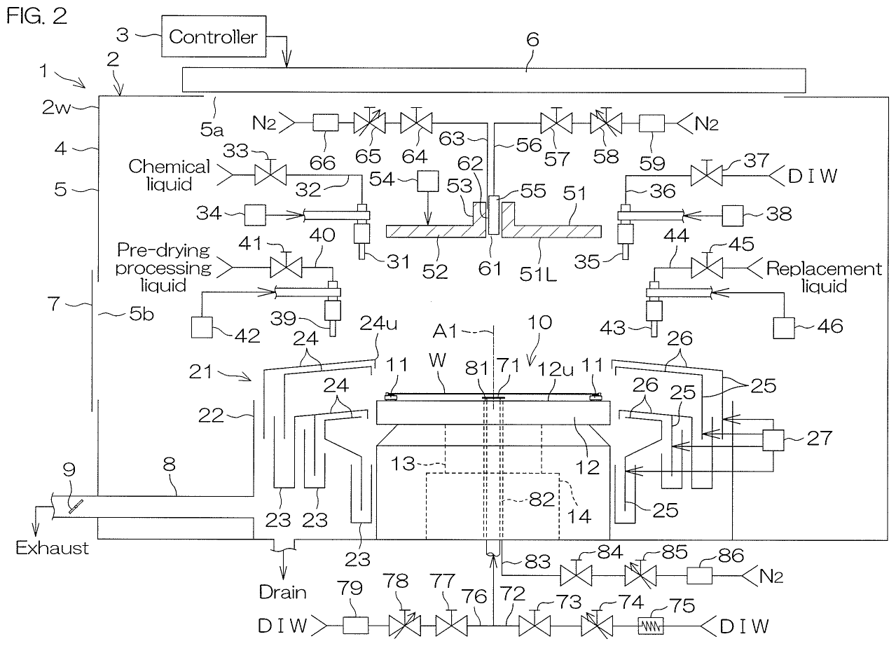

FIG. 2 is a schematic view as viewed horizontally of an interior of a processing unit 2 included in the substrate processing apparatus 1.

The processing unit 2 is a wet processing unit 2w that supplies processing liquids to the substrate W. The processing unit 2 includes a box-shaped chamber 4, having an internal space, a spin chuck 10, holding a single substrate W in a horizontal orientation inside the chamber 4 and meanwhile rotating the substrate W around a vertical rotational axis A1 passing through a central portion of the substrate W, and a cylindrical processing cup 21, surrounding the spin chuck 10 around the rotational axis A1.

The chamber 4 includes a box-shaped partition wall 5, provided with a carry-in/carry-out port 5b, through which the substrate W passes, and a shutter 7, opening and closing the carry-in/carry-out port 5b. An FFU 6 (fan filter unit) is disposed above an air blowing port 5a provided at an upper portion of the partition wall 5. The FFU 6 constantly supplies clean air (air filtered by a filter) into the chamber 4 from the air blowing port 5a. Gas inside the chamber 4 is exhausted from the chamber 4 through an exhaust duct 8 connected to a bottom portion of the processing cup 21. A down flow of clean air is thereby formed constantly inside the chamber 4. A flow rate of exhaust exhausted to the exhaust duct 8 is changed in accordance with an opening degree of an exhaust valve 9 disposed inside the exhaust duct 8.

The spin chuck 10 includes a disk-shaped spin base 12, held in a horizontal orientation, a plurality of chuck pins 11, holding the substrate Win a horizontal orientation above the spin base 12, a spin shaft 13, extending downward from a central portion of the spin base 12, and a spin motor 14, rotating the spin shaft 13 to rotate the spin base 12 and the plurality of chuck pins 11. The spin chuck 10 is not restricted to a clamping type chuck, with which the plurality of chuck pins 11 are made to contact an outer peripheral surface of the substrate W, and may instead be a vacuum type chuck that holds the substrate W horizontally by suctioning a rear surface (lower surface) of the substrate W, which is a non-device forming surface, onto an upper surface 12u of the spin base 12.

The processing cup 21 includes a plurality of guards 24, receiving a processing liquid expelled outward from the substrate W, a plurality of cups 23, receiving the processing liquid guided downward by the plurality of guards 24, and a circular cylindrical outer wall member 22, surrounding the plurality of guards 24 and the plurality of cups 23. FIG. 2 shows an example where four guards 24 and three cups 23 are provided and the cup 23 at an outermost side is made integral to the third top guard 24.

Each guard 24 includes a circular cylindrical portion 25, surrounding the spin chuck 10, and a circular annular ceiling portion 26, extending obliquely upward toward the rotational axis A1 from an upper end portion of the circular cylindrical portion 25. The plurality of ceiling portions 26 are overlapped one above the other, and the plurality of circular cylindrical portions 25 are disposed concentrically. A circular annular upper ends of the ceiling portions 26 correspond to upper ends 24u of the guards 24 surrounding the substrate W and the spin base 12 in plan view. The plurality of cups 23 are respectively disposed below the plurality of circular cylindrical portions 25. The cups 23 form annular liquid receiving grooves that receive the processing liquid guided downward by the guards 24.

The processing unit 2 further includes a guard elevating/lowering unit 27 that elevates and lowers the plurality of guards 24 individually. The guard elevating/lowering unit 27 positions each guard 24 at any position from an upper position to a lower position. FIG. 2 shows a state where two guards 24 are disposed at the upper positions and the remaining two guards 24 are disposed at the lower positions. The upper position is a position at which the upper end 24u of the guard 24 is disposed higher than a holding position, at which the substrate W held by the spin chuck 10 is disposed. The lower position is a position at which the upper end 24u of the guard 24 is disposed lower than the holding position.

At least one guard 24 is disposed at the upper position when a processing liquid is supplied to the substrate W. When the processing liquid is supplied to the substrate W in this state, the processing liquid supplied to the substrate W is spun off to a periphery of the substrate W. The spun-off processing liquid collides with an inner surface of the guard 24 facing the substrate W horizontally and is guided to the cup 23 corresponding to the guard 24. The processing liquid expelled from the substrate W is thereby collected in the processing cup 21.

The processing unit 2 further includes a plurality of nozzles discharging processing liquids toward the substrate W held by the spin chuck 10. The plurality of nozzles include a chemical liquid nozzle 31, discharging a chemical liquid toward an upper surface of the substrate W, a rinse liquid nozzle 35, discharging a rinse liquid toward the upper surface of the substrate W, a pre-drying processing liquid nozzle 39, discharging a pre-drying processing liquid toward the upper surface of the substrate W, and a replacement liquid nozzle 43, discharging a replacement liquid toward the upper surface of the substrate W.

The chemical liquid nozzle 31 maybe a scan nozzle, movable horizontally inside the chamber 4, or may be a fixed nozzle, fixed with respect to the partition wall 5 of the chamber 4. The same applies to the rinse liquid nozzle 35, the pre-drying processing liquid nozzle 39, and the replacement liquid nozzle 43. FIG. 2 shows an example where the chemical liquid nozzle 31, the rinse liquid nozzle 35, the pre-drying processing liquid nozzle 39, and the replacement liquid nozzle 43 are scan nozzles and four nozzle moving units respectively corresponding to the four nozzles are provided.

The chemical liquid nozzle 31 is connected to a chemical liquid piping 32 guiding the chemical liquid to the chemical liquid 31. When a chemical liquid valve 33 interposed in the chemical liquid piping 32 is opened, the chemical liquid is discharged continuously downward from a discharge port of the chemical liquid nozzle 31. The chemical liquid discharged from the chemical liquid nozzle 31 may be a liquid containing at least one of sulfuric acid, nitric acid, hydrochloric acid, hydrofluoric acid, phosphoric acid, acetic acid, ammonia water, hydrogen peroxide water, an organic acid (for example, citric acid, oxalic acid, etc.), an organic alkali (for example, TMAH: tetramethylammonium hydroxide, etc.), a surfactant, and a corrosion inhibitor or may be a liquid other than these.

Although unillustrated, the chemical liquid valve 33 includes a valve body, provided with an internal flow passage, through which the chemical liquid flows, and an annular valve seat, surrounding the internal flow passage, a valve element, movable with respect to the valve seat, and an actuator, moving the valve element between a closed position, at which the valve element contacts the valve seat, and an open position, at which the valve element is separated from the valve seat. The same applies to other valves. The actuator may be a pneumatic actuator or an electric actuator or may be an actuator other than these. The controller 3 controls the actuator to open and close the chemical liquid valve 33.

The chemical liquid nozzle 31 is connected to a nozzle moving unit 34 that moves the chemical liquid nozzle 31 in at least one of a vertical direction and a horizontal direction. The nozzle moving unit 34 moves the chemical liquid nozzle 31 horizontally between a processing position, at which the chemical liquid discharged from the chemical liquid nozzle 31 lands on the upper surface of the substrate W, and a standby position, at which the chemical liquid nozzle 31 is positioned at a periphery of the processing cup 21 in plan view.

The rinse liquid nozzle 35 is connected to a rinse liquid piping 36 that guides the rinse liquid to the rinse liquid nozzle 35. When a rinse liquid valve 37 interposed in the rinse liquid piping 36 is opened, the rinse liquid is discharged continuously downward from a discharge port of the rinse liquid nozzle 35. The rinse liquid discharged from the rinse liquid nozzle 35 is, for example, pure water (DIW (deionized water)). The rinse liquid may instead be any of carbonated water, electrolyzed ion water, hydrogen water, ozone water, and aqueous hydrochloric acid solution of dilute concentration (of, for example, approximately 10 to 100 ppm), etc.

The rinse liquid nozzle 35 is connected to a nozzle moving unit 38 that moves the rinse liquid nozzle 35 in at least one of the vertical direction and the horizontal direction. The nozzle moving unit 38 moves the rinse liquid nozzle 35 horizontally between a processing position, at which the rinse liquid discharged from the rinse liquid nozzle 35 lands on the upper surface of the substrate W, and a standby position, at which the rinse liquid nozzle 35 is positioned at the periphery of the processing cup 21 in plan view.

The pre-drying processing liquid nozzle 39 is connected to a pre-drying processing liquid piping 40 that guides the processing liquid to the pre-drying processing liquid nozzle 39. When a pre-drying processing liquid valve 41 interposed in the pre-drying processing liquid piping 40 is opened, the processing liquid is discharged continuously downward from a discharge port of the pre-drying processing liquid nozzle 39. Similarly, the replacement liquid nozzle 43 is connected to a replacement liquid piping 44 that guides the replacement liquid to the replacement liquid nozzle 43. When a replacement liquid valve 45 interposed in the replacement liquid piping 44 is opened, the replacement liquid is discharged continuously downward from a discharge port of the replacement liquid nozzle 43.

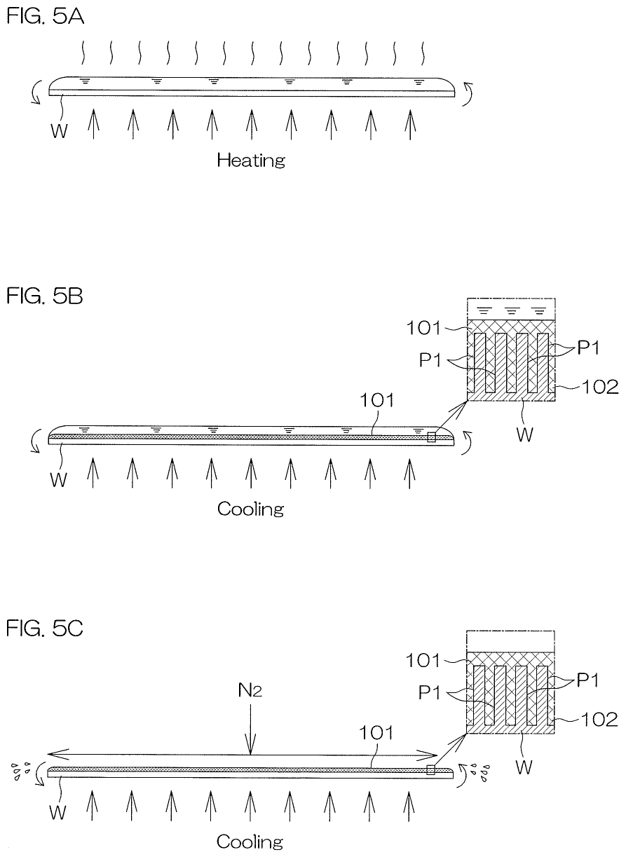

The pre-drying processing liquid contains a solidified body forming substance, which forms (which is a substance for forming) a solidified body 101 (see FIG. 5B), and a dissolution substance, which blends together with the solidified body forming substance. The pre-drying processing liquid is a solution in which a solute and a solvent are blended together uniformly. Either of the solidified body forming substance and the dissolution substance may be the solute. If a solvent that blends together with the solidified body forming substance and the dissolution substance is contained in the pre-drying processing liquid, both the solidified body forming substance and the dissolution substance may be solutes.

The solidified body forming substance may be a sublimable substance that changes from a solid to a gas without transition to a liquid at ordinary temperature or ordinary pressure or may be a substance other than a sublimable substance. Similarly, the dissolution substance may be a sublimable substance or may be a substance other than a sublimable substance. Two or more types of sublimable substances may be contained in the pre-drying processing liquid. That is, both the solidified body forming substance and the dissolution substance may be sublimable substances and a sublimable substance of a type differing from the solidified body forming substance and the dissolution substance may be contained in the pre-drying processing liquid.

The sublimable substance may, for example, be any of alcohols, such as 2-methyl-2-propanol (synonyms:

tert-butyl alcohol, t-butyl alcohol), cyclohexanol, etc., fluorohydrocarbons, 1,3,5-trioxane (synonym: metaformaldehyde), camphor (synonyms: camphre, campher), naphthalene, and iodine or may be a substance other than these.

The solvent may, for example, be at least one type selected from the group consisting of pure water, IPA, HFE (hydrofluoroether), acetone, PGMEA (propylene glycol monomethyl ether acetate), PGEE (propylene glycol monoethyl ether, 1-ethoxy-2-propanol), and ethylene glycol. Or, the sublimable substance may be the solvent.

In the following, an example where the solidified body forming substance is a sublimable substance shall be described. If both the solidified body forming substance and the dissolution substance are sublimable substances, the pre-drying processing liquid may be a solution containing just cyclohexanol and tert-butyl alcohol. Or, a solvent, such as IPA, maybe contained with the above. A vapor pressure of IPA is higher than a vapor pressure of tert-butyl alcohol and higher than a vapor pressure of cyclohexanol. The vapor pressure of tert-butyl alcohol is higher than the vapor pressure of cyclohexanol. tert-Butyl alcohol thus evaporates at a higher evaporation rate than an evaporation rate of cyclohexanol.

A freezing point (freezing point at 1 atmosphere; the same applies hereinafter) of cyclohexanol is 24° C. or a value in a vicinity thereof. A freezing point of tert-butyl alcohol is 25° C. or a value in a vicinity thereof. If the pre-drying processing liquid is a solution containing just cyclohexanol and tert-butyl alcohol, a freezing point of the pre-drying processing liquid is lower than the freezing point of cyclohexanol and lower than the freezing point of tert-butyl alcohol. That is, the freezing point of the pre-drying processing liquid is lower than the freezing points of the respective components contained in the pre-drying processing liquid. The freezing point of the pre-drying processing liquid is lower than room temperature (23° C. or a value in a vicinity thereof). The substrate processing apparatus 1 is disposed inside a clean room maintained at room temperature. The pre-drying processing liquid can thus be maintained as a liquid even if the pre-drying processing liquid is not heated.

As shall be described below, the replacement liquid is supplied to the upper surface of the substrate W that is covered by a liquid film of the rinse liquid and the pre-drying processing liquid is supplied to the upper surface of the substrate W that is covered by a liquid film of the replacement liquid. The replacement liquid is a liquid that blends together with both the rinse liquid and the pre-drying processing liquid. The replacement liquid is, for example, IPA or HFE. The replacement liquid may be a liquid mixture of IPA and HFE or may contain at least one of IPA and HFA and a component other than these. IPA and HFE are liquids that blend together with both water and fluorohydrocarbons. Although low in solubility, HFE does mix with IPA and therefore after replacement of the rinse liquid on the substrate W with IPA, HFE may be supplied to the substrate W.

When the replacement liquid is supplied to the upper surface of the substrate W that is covered by the liquid film of the rinse liquid, most of the rinse liquid on the substrate W is washed away by the replacement liquid and is expelled from the substrate W. A remaining minute amount of rinse liquid blends into the replacement liquid and diffuses inside the replacement liquid. The diffused rinse liquid is expelled from the substrate W together with the replacement liquid. The rinse liquid on the substrate W can thus be replaced efficiently by the replacement liquid. By the same reason, the replacement liquid on the substrate W can be replaced efficiently by the pre-drying processing liquid. The rinse liquid contained in the pre-drying processing liquid on the substrate W can thereby be decreased.

The pre-drying processing liquid nozzle 39 is connected to a nozzle moving unit 42 that moves the pre-drying processing liquid nozzle 39 in at least one of the vertical direction and the horizontal direction. The nozzle moving unit 42 moves the pre-drying processing liquid nozzle 39 horizontally between a processing position, at which the pre-drying processing liquid discharged from the pre-drying processing liquid nozzle 39 lands on the upper surface of the substrate W, and a standby position, at which the pre-drying processing liquid nozzle 39 is positioned at the periphery of the processing cup 21 in plan view.

Similarly, the replacement liquid nozzle 43 is connected to a nozzle moving unit 46 that moves the replacement liquid nozzle 43 in at least one of the vertical direction and the horizontal direction. The nozzle moving unit 46 moves the replacement liquid nozzle 43 horizontally between a processing position, at which the replacement liquid discharged from the replacement liquid nozzle 43 lands on the upper surface of the substrate W, and a standby position, at which the replacement liquid nozzle 43 is positioned at the periphery of the processing cup 21 in plan view.

The processing unit 2 further includes a blocking member 51 disposed above the spin chuck 10. FIG. 2 shows an example where the blocking member 51 is a disk-shaped blocking plate. The blocking member 51 includes a disk portion 52 disposed horizontally above the spin chuck 10. The blocking member 51 is supported horizontally by a cylindrical support shaft 53 extending upward from a central portion of the disk portion 52. A center line of the disk portion 52 is disposed on the rotational axis A1 of the substrate W. A lower surface of the disk portion 52 corresponds to a lower surface 51L of the blocking member 51. The lower surface 51L of the blocking member 51 is a facing surface facing the upper surface of the substrate W. The lower surface 51L of the blocking member 51 is parallel to the upper surface of the substrate W and has an outer diameter not less than a diameter of the substrate W.

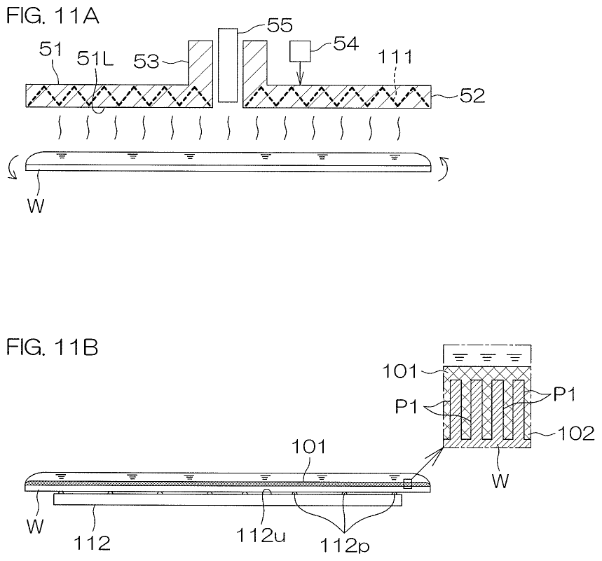

The blocking member 51 is connected to a blocking member elevating/lowering unit 54 that elevates and lowers the blocking member 51 vertically. The blocking member elevating/lowering unit 54 positions the blocking member 51 at any position from an upper position (position shown in FIG. 2) to a lower position (see FIG. 11A). The lower position is a proximity position, at which the lower surface 51L of the blocking member 51 approaches the upper surface of the substrate W to a height such that a scan nozzle, such as the chemical liquid nozzle 31, etc., cannot enter between the substrate W and the blocking member 51. The upper position is a separated position at which the blocking member 51 is retreated to a height allowing entry of a scan nozzle between the blocking member 51 and the substrate W.

The plurality of nozzles include a central nozzle 55 that discharges a processing fluid, such as a processing liquid, a processing gas, etc., downward via an upper central opening 61 opening at a central portion of the lower surface 51L of the blocking member 51. The central nozzle 55 extends up and down along the rotational axis A1. The central nozzle 55 is disposed inside a penetrating hole penetrating up and down through a central portion of the blocking member 51. An inner peripheral surface of the blocking member 51 surrounds an outer peripheral surface of the central nozzle 55 across an interval in a radial direction (direction orthogonal to the rotational axis A1). The central nozzle 55 is elevated and lowered together with the blocking member 51. A discharge port of the central nozzle 55 that discharges a processing liquid is disposed above the upper central opening 61 of the blocking member 51.

The central nozzle 55 is connected to an upper gas piping 56 that guides an inert gas to the central nozzle 55. The substrate processing apparatus 1 may include an upper temperature controller 59 that heats or cools the inert gas discharged from the central nozzle 55. When an upper gas valve 57, interposed in the upper gas piping 56, is opened, the inert gas is discharged continuously downward from the discharge port of the central nozzle 55 at a flow rate corresponding to an opening degree of a flow control valve 58 that changes the flow rate of the inert gas. The inert gas discharged from the central nozzle 55 is nitrogen gas. The inert gas may instead be a gas other than nitrogen gas, such as helium gas or argon gas, etc.

The inner peripheral surface of the blocking member 51 and the outer peripheral surface of the central nozzle 55 define a cylindrical upper gas flow passage 62 that extends up and down. The upper gas flow passage 62 is connected to an upper gas piping 63 that guides an inert gas to the upper central opening 61 of the blocking member 51. The substrate processing apparatus 1 may include an upper temperature controller 66 that heats or cools the inert gas discharged from the upper central opening 61 of the blocking member 51. When an upper gas valve 64, interposed in the upper gas piping 63, is opened, the inert gas is discharged continuously downward from the upper central opening 61 of the blocking member 51 at a flow rate corresponding to an opening degree of a flow control valve 65 that changes the flow rate of the inert gas. The inert gas discharged from the upper central opening 61 of the blocking member 51 is nitrogen gas. The inert gas may instead be a gas other than nitrogen gas, such as helium gas or argon gas, etc.

The plurality of nozzles include a lower surface nozzle 71 that discharges a processing liquid toward a lower surface central portion of the substrate W. The lower surface nozzle 71 includes a nozzle disk portion, disposed between the upper surface 12u of the spin base 12 and the lower surface of the substrate W, and a nozzle cylindrical portion, extending downward from the nozzle disk portion. A discharge port of the lower surface nozzle 71 opens at an upper surface central portion of the nozzle disk portion. When the substrate W is held by the spin chuck 10, the discharge port of the lower surface nozzle 71 faces the lower surface central portion of the substrate W in an up/down direction.

The lower surface nozzle 71 is connected to a heating fluid piping 72 that guides hot water (pure water of higher temperature than room temperature), which is an example of a heating fluid, to the lower surface nozzle 71. Pure water supplied to the lower surface nozzle 71 is heated by a lower heater 75 interposed in the heating fluid piping 72. When a heating fluid valve 73, interposed in the heating fluid piping 72, is opened, the hot water is discharged continuously upward from the discharge port of the lower surface nozzle 71 at a flow rate corresponding to an opening degree of a flow control valve 74 that changes the flow rate of the hot water. The hot water is thereby supplied to the lower surface of the substrate W.

The lower surface nozzle 71 is further connected to a cooling fluid piping 76 that guides cold water (pure water of lower temperature than room temperature), which is an example of a cooling fluid, to the lower surface nozzle 71. Pure water supplied to the lower surface nozzle 71 is cooled by a cooler 79 interposed in the cooling fluid piping 76. When a cooling fluid valve 77, interposed in the cooling fluid piping 76, is opened, the cold water is discharged continuously upward from the discharge port of the lower surface nozzle 71 at a flow rate corresponding to an opening degree of a flow control valve 78 that changes the flow rate of the cold water. The cold water is thereby supplied to the lower surface of the substrate W.

An outer peripheral surface of the lower surface nozzle 71 and an inner peripheral surface of the spin base 12 define a cylindrical lower gas flow passage 82 that extends up and down. The lower gas flow passage 82 includes a lower central opening 81 opening at a central portion of the upper surface 12u of the spin base 12. The lower gas flow passage 82 is connected to a lower gas piping 83 that guides an inert gas to the lower central opening 81 of the spin base 12. The substrate processing apparatus 1 may include a lower temperature controller 86 that heats or cools the inert gas discharged from the lower central opening 81 of the spin base 12. When a lower gas valve 84, interposed in the lower gas piping 83, is opened, the inert gas is discharged continuously upward from the lower central opening 81 of the spin base 12 at a flow rate corresponding to an opening degree of a flow control valve 85 that changes the flow rate of the inert gas.

The inert gas discharged from the lower central opening 81 of the spin base 12 is nitrogen gas. The inert gas may instead be a gas other than nitrogen gas, such as helium gas or argon gas, etc. When the lower central opening 81 of the spin base 12 discharges the nitrogen gas when the substrate W is held by the spin chuck 10, the nitrogen gas flows radially in all directions between the lower surface of the substrate W and the upper surface 12u of the spin base 12. A space between the substrate W and the spin base 12 is thereby filled with the nitrogen gas.

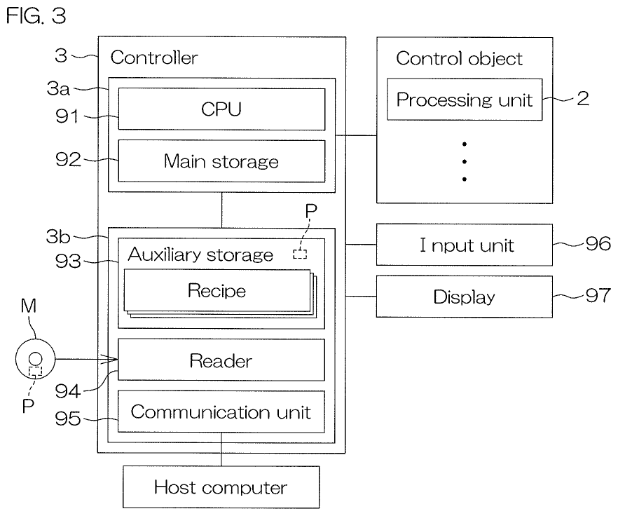

FIG. 3 is a block diagram showing hardware of the controller 3.

The controller 3 is a computer that includes a computer main body 3a and a peripheral unit 3b, connected to the computer main body 3a. The computer main body 3a includes a CPU 91 (central processing unit) that executes various instructions and a main storage 92 that stores information. The peripheral unit 3b includes an auxiliary storage 93, storing information of a program P, etc. , a reader 94, reading information from a removable medium M, and a communication unit 95, communicating with another device, such as a host computer, etc.

The controller 3 is connected to an input unit 96 and a display 97. The input unit 96 is operated when an operator, such as a user or maintenance staff, etc., inputs information into the substrate processing apparatus 1. The information is displayed on a screen of the display 97. The input unit 96 may be any of a keyboard, a pointing device, and a touch panel or may be a device other than these. The substrate processing apparatus 1 may be provided with a touch panel display, serving as the input unit 96 and the display 97.

The CPU 91 executes the program P stored in the auxiliary storage 93. The program P inside the auxiliary storage 93 may be that which has been installed in advance in the controller 3 or may be that which has been sent to the auxiliary storage 93 from the removable medium M through the reader 94, or that which has been sent to the auxiliary storage 93 from an external device, such as the host computer, etc., through the communication unit 95.

The auxiliary storage 93 and the removable medium M are nonvolatile memories that hold memory even when electric power is not supplied. The auxiliary storage 93 is, for example, a magnetic storage, such as a hard disk drive, etc. The removable medium M is, for example, an optical disk, such as a compact disk, etc., or a semiconductor memory, such as a memory card, etc. The removable medium M is an example of a computer-readable recording medium in which the program P is recorded. The removable medium M is a non-temporary, tangible recording medium.

The auxiliary storage 93 stores a plurality of recipes. Each recipe is information specifying processing contents, processing conditions, and processing procedures for the substrate W. The plurality of recipes differ from each other in at least one of the processing contents, the processing conditions, and the processing procedures for the substrate W. The controller 3 controls the substrate processing apparatus 1 such that the substrate W is processed in accordance with the recipe designated by the host computer. The following respective steps are executed by the controller 3 controlling the substrate processing apparatus 1. In other words, the controller 3 is programed to execute the following respective steps.

Two examples of processing of the substrate W shall now be described.

The substrate W to be processed is, for example, a semiconductor wafer, such as a silicon wafer, etc. The front surface of the substrate W corresponds to a device forming surface on which a device, such as a transistor, capacitor, etc., is formed. The substrate W may be a substrate W having patterns P1 (see FIG. 5B) formed on the front surface of the substrate W that is a pattern forming surface or may be a substrate W without the patterns P1 formed on the front surface of the substrate W. In the latter case, the patterns P1 may be formed in a chemical liquid supplying step to be described below.

First Processing Example

First, an example where the pre-drying processing liquid on the substrate W is cooled to precipitate the solidified body 101, containing the solidified body forming substance, in the pre-drying processing liquid shall be described.

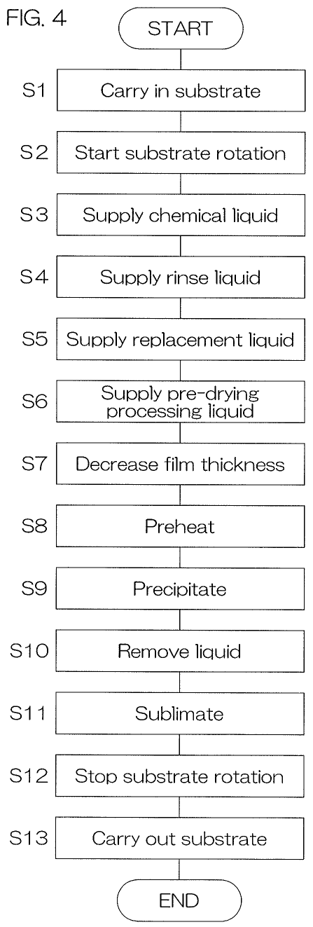

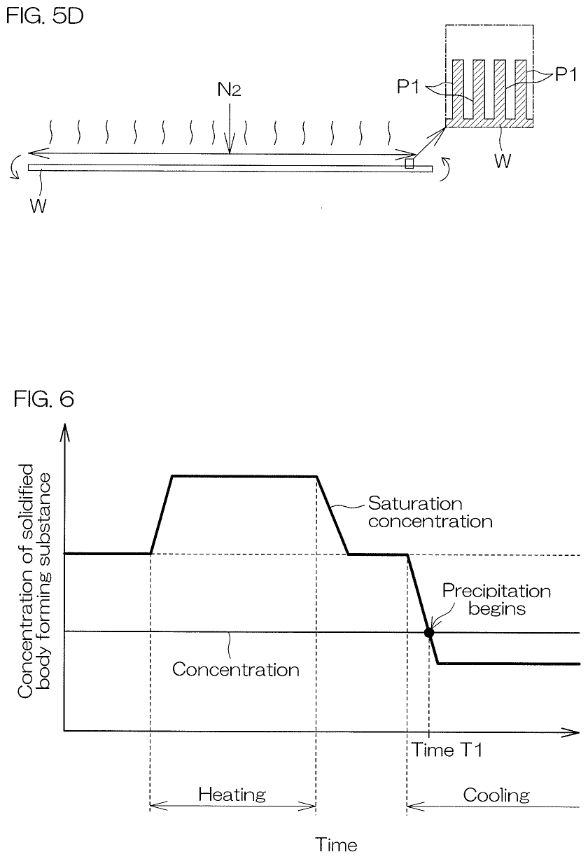

FIG. 4 is a process flowchart for describing an example (first processing example) of processing of the substrate W performed by the substrate processing apparatus 1. FIG. 5A to FIG. 5D are schematic views, each showing a state of the substrate W when the processing of the substrate W shown in FIG. 4 is being performed. FIG. 6 is a graph showing an image of how a concentration and a saturation concentration of a solidified body forming substance in the pre-drying processing liquid change. FIG. 2 and FIG. 4 shall be referenced in the following description. FIG. 5A to FIG. 5D and FIG. 6 shall be referenced where appropriate.

When the substrate W is to be processed by the substrate processing apparatus 1, a carry-in step (step S1 of FIG. 4) of carrying the substrate W into the chamber 4 is performed.

Specifically, in a state where the blocking member 51 is positioned at the upper position, all of the guards 24 are positioned at the lower positions, and all of the scan nozzles are positioned at the standby positions, the center robot CR (see FIG. 1) makes the hand H1 enter inside the chamber 4 while supporting the substrate W with the hand H1. The center robot CR then places the substrate W, on the hand H1, on the plurality of chuck pins 11 in a state where the front surface of the substrate W is faced upward. Thereafter, the plurality of chuck pins 11 are pressed against the outer peripheral surface of the substrate W and the substrate W is gripped. After placing the substrate Won the spin chuck 10, the center robot CR makes the hand H1 retreat from the interior of the chamber 4.

Next, the upper gas valve 64 and the lower gas valve 84 are opened and the upper central opening 61 of the blocking member 51 and the lower central opening 81 of the spin base 12 start discharge of nitrogen gas. A space between the substrate W and the blocking member 51 is thereby filled with the nitrogen gas. Similarly, the space between the substrate W and the spin base 12 is filled with the nitrogen gas. Meanwhile, the guard elevating/lowering unit 27 elevates at least one of the guards 24 from the lower position to the upper position. Thereafter, the spin motor 14 is driven and rotation of the substrate W is started (step S2 of FIG. 4). The substrate W is thereby rotated at a liquid supplying speed.

Next, the chemical liquid supplying step (step S3 of FIG. 4) of supplying the chemical liquid to the upper surface of the substrate W and forming a liquid film of the chemical liquid that covers an entirety of the upper surface of the substrate W is performed.

Specifically, in a state where the blocking member 51 is positioned at the upper position and at least one of the guards 24 is positioned at the upper position, the nozzle moving unit 34 moves the chemical liquid nozzle 31 from the standby position to the processing position. Thereafter, the chemical liquid valve 33 is opened and the chemical liquid nozzle 31 starts discharge of the chemical liquid. When a predetermined time elapses from the opening of the chemical liquid valve 33, the chemical liquid valve 33 is closed and the discharge of the chemical liquid is stopped. Thereafter, the nozzle moving unit 34 moves the chemical liquid nozzle 31 to the standby position.

The chemical liquid discharged from the chemical liquid nozzle 31 lands on the upper surface of the substrate W rotating at the liquid supplying speed and thereafter flows outward along the upper surface of the substrate W due to a centrifugal force. The chemical liquid is thus supplied to the entirety of the upper surface of the substrate W and the liquid film of the chemical liquid that covers the entirety of the upper surface of the substrate W is formed. When the chemical liquid nozzle 31 is discharging the chemical liquid, the nozzle moving unit 34 may move a liquid landing position of the chemical liquid with respect to the upper surface of the substrate W such that the liquid landing position passes a central portion and an outer peripheral portion or may keep the liquid landing position still at the central portion.

Next, a rinse liquid supplying step (step S4 of FIG. 4) of supplying pure water, which is an example of the rinse liquid, to the upper surface of the substrate W to rinse off the chemical liquid on the substrate W is performed.

Specifically, in a state where the blocking member 51 is positioned at the upper position and at least one of the guards 24 is positioned at the upper position, the nozzle moving unit 38 moves the rinse liquid nozzle 35 from the standby position to the processing position. Thereafter, the rinse liquid valve 37 is opened and the rinse liquid nozzle 35 starts discharge of the rinse liquid. Before the discharge of pure water is started, the guard elevating/lowering unit 27 may move at least one of the guards 24 vertically to switch the guard 24 that receives the liquid expelled from the substrate W. When a predetermined time elapses from the opening of the rinse liquid valve 37, the rinse liquid valve 37 is closed and the discharge of the rinse liquid is stopped. Thereafter, the nozzle moving unit 38 moves the rinse liquid nozzle 35 to the standby position.

The pure water discharged from the rinse liquid nozzle 35 lands on the upper surface of the substrate W rotating at the liquid supplying speed and thereafter flows outward along the upper surface of the substrate W due to the centrifugal force. The chemical liquid on the substrate W is replaced by the pure water discharged from the rinse liquid nozzle 35. A liquid film of the pure water that covers the entirety of the upper surface of the substrate W is thereby formed. When the rinse liquid nozzle 35 is discharging the pure water, the nozzle moving unit 38 may move a liquid landing position of the pure water with respect to the upper surface of the substrate W such that the liquid landing position passes the central portion and the outer peripheral portion or may keep the liquid landing position still at the central portion.

Next, a replacement liquid supplying step (step S5 of FIG. 4) of supplying the replacement liquid, which blends together with both the rinse liquid and the pre-drying processing liquid, to the upper surface of the substrate Wand replacing the pure water on the substrate W with the replacement liquid is performed.

Specifically, in a state where the blocking member 51 is positioned at the upper position and at least one of the guards 24 is positioned at the upper position, the nozzle moving unit 46 moves the replacement liquid nozzle 43 from the standby position to the processing position. Thereafter, the replacement liquid valve 45 is opened and the replacement liquid nozzle 43 starts discharge of the replacement liquid. Before the discharge of the replacement liquid is started, the guard elevating/lowering unit 27 may move at least one of the guards 24 vertically to switch the guard 24 that receives the liquid expelled from the substrate W. When a predetermined time elapses from the opening of the replacement liquid valve 45, the replacement liquid valve 45 is closed and the discharge of the replacement liquid is stopped. Thereafter, the nozzle moving unit 46 moves the replacement liquid nozzle 43 to the standby position.

The replacement liquid discharged from the replacement liquid nozzle 43 lands on the upper surface of the substrate W rotating at the liquid supplying speed and thereafter flows outward along the upper surface of the substrate W due to the centrifugal force. The pure water on the substrate W is replaced by the replacement liquid discharged from the replacement liquid nozzle 43. A liquid film of the replacement liquid that covers the entirety of the upper surface of the substrate W is thereby formed. When the replacement liquid nozzle 43 is discharging the replacement liquid, the nozzle moving unit 46 may move a liquid landing position of the replacement liquid with respect to the upper surface of the substrate W such that the liquid landing position passes the central portion and the outer peripheral portion or may keep the liquid landing position still at the central portion.

Next, the pre-drying processing liquid supplying step (step S6 of FIG. 4) of supplying the pre-drying processing liquid to the upper surface of the substrate W and forming a liquid film of the pre-drying processing liquid on the substrate W is performed.

Specifically, in a state where the blocking member 51 is positioned at the upper position and at least one of the guards 24 is positioned at the upper position, the nozzle moving unit 42 moves the pre-drying processing liquid nozzle 39 from the standby position to the processing position. Thereafter, the pre-drying processing liquid valve 41 is opened and the pre-drying processing liquid nozzle 39 starts discharge of the pre-drying processing liquid. Before the discharge of the pre-drying processing liquid is started, the guard elevating/lowering unit 27 may move at least one of the guards 24 vertically to switch the guard 24 that receives the liquid expelled from the substrate W. When a predetermined time elapses from the opening of the pre-drying processing liquid valve 41, the pre-drying processing liquid valve 41 is closed and the discharge of the pre-drying processing liquid is stopped. Thereafter, the nozzle moving unit 42 moves the pre-drying processing liquid nozzle 39 to the standby position.

The pre-drying processing liquid discharged from the pre-drying processing liquid nozzle 39 lands on the upper surface of the substrate W rotating at the liquid supplying speed and thereafter flows outward along the upper surface of the substrate W due to the centrifugal force. The replacement liquid on the substrate W is replaced by the pre-drying processing liquid discharged from the pre-drying processing liquid nozzle 39. A liquid film of the pre-drying processing liquid that covers the entirety of the upper surface of the substrate W is thereby formed. When the pre-drying processing liquid nozzle 39 is discharging the pre-drying processing liquid, the nozzle moving unit 42 may move a liquid landing position of the pre-drying processing liquid with respect to the upper surface of the substrate W such that the liquid landing position passes the central portion and the outer peripheral portion or may keep the liquid landing position still at the central portion.

Next, a film thickness decreasing step (step S7 of FIG. 4) of removing a portion of the pre-drying processing liquid on the substrate W to decrease a film thickness (thickness of the liquid film) of the pre-drying processing liquid on the substrate W while maintaining the state where the entirety of the upper surface of the substrate W is covered by the liquid film of the pre-drying processing liquid is performed.

Specifically, before or after the discharge of the pre-drying processing liquid is stopped, the spin motor 14 decreases a rotational speed of the substrate W to a film thickness decreasing speed and maintains the speed at the film thickness decreasing speed. The film thickness decreasing speed is set such that when the discharge of the pre-drying processing liquid is stopped, the state where the entirety of the upper surface of the substrate W is covered by the liquid film of the pre-drying processing liquid is maintained. The film thickness decreasing speed is, for example, from several dozen rpm to 100 rpm. The pre-drying processing liquid on the substrate W is expelled outward from the substrate W by the centrifugal force even after the discharge of the pre-drying processing liquid is stopped. The thickness of the liquid film of the pre-drying processing liquid on the substrate W thus decreases. When the pre-drying processing liquid on the substrate W is expelled to some degree, an amount of the pre-drying processing liquid expelled from the substrate W per unit time decreases to zero or substantially zero. The thickness of the liquid film of the pre-drying processing liquid on the substrate W thereby stabilizes.

Next, a preheating step (step S8 of FIG. 4) of supplying, to the lower surface of the substrate W, hot water of higher temperature than the pre-drying processing liquid on the substrate W to heat the pre-drying processing liquid on the substrate W to a preheating temperature is performed.

Specifically, the blocking member elevating/lowering unit 54 lowers the blocking member 51 from the upper position to the lower position. The lower surface 51L of the blocking member 51 thereby approaches the upper surface of the substrate W. At this point, the upper gas valve 64 is opened and the upper central opening 61 of the blocking member 51 is discharging nitrogen gas downward. Before or after the blocking member 51 reaches the lower position, the spin motor 14 increases the rotational speed of the substrate W to the liquid supplying speed greater than the film thickness decreasing speed and maintains the speed at the liquid supplying speed. Then, in a state where the blocking member 51 is positioned at the lower position and the substrate W is rotating at the liquid supplying speed, the heating fluid valve 73 is opened and the lower surface nozzle 71 starts discharge of hot water.

The hot water discharged upward from the lower surface nozzle 71 lands on the lower surface central portion of the substrate W and thereafter flows outward along the lower surface of the rotating substrate W. The hot water is thereby supplied to an entirety of the lower surface of the substrate W. The temperature of the hot water is higher than room temperature and lower than a boiling point of water. A temperature of the substrate W and a temperature of the pre-drying processing liquid on the substrate W are lower than the temperature of the hot water. The pre-drying processing liquid on the substrate W is thus heated uniformly via the substrate W. The pre-drying processing liquid on the substrate W is thus heated to the preheating temperature. Then, when a predetermined time elapses from the opening of the heating fluid valve 73, the heating fluid valve 73 is closed and the discharge of the hot water is stopped.

As shown in FIG. 5A, when the pre-drying processing liquid on the substrate W is heated, the solidified body forming substance and the dissolution substance contained in the pre-drying processing liquid evaporate. A portion of the pre-drying processing liquid on the substrate W thereby evaporates and the thickness of the pre-drying processing liquid decreases. A vapor pressure of the dissolution substance is higher than a vapor pressure of the solidified body forming substance and therefore an evaporation rate of the dissolution substance is higher than an evaporation rate of the solidified body forming substance. Therefore, as the heating of the pre-drying processing liquid is continued, a concentration of the solidified body forming substance in the pre-drying processing liquid increases and the freezing point of the pre-drying processing liquid increases. The heating of the pre-drying processing liquid may be stopped before crystals containing the solidified body forming substance precipitate or may be stopped after the crystals containing the solidified body forming substance precipitate inside the pre-drying processing liquid.

Next, a precipitating step (step S9 of FIG. 4) of supplying, to the lower surface of the substrate W, cold water of lower temperature than the pre-drying processing liquid on the substrate W to cool the pre-drying processing liquid on the substrate W to decrease a saturation concentration of the solidified body forming substance in the pre-drying processing liquid on the substrate W to a value lower than the concentration of the solidified body forming substance in the pre-drying processing liquid on the substrate W is performed.

Specifically, in the state where the blocking member 51 is positioned at the lower position and the substrate W is rotating at the liquid supplying speed after the heating fluid valve 73 is closed, the cooling fluid valve 77 is opened and the lower surface nozzle 71 starts discharge of cold water. The cold water discharged upward from the lower surface nozzle 71 lands on the lower surface central portion of the substrate W and thereafter flows outward along the lower surface of the rotating substrate W. The cold water is thereby supplied to the entirety of the lower surface of the substrate W. The temperature of the cold water is lower than room temperature and higher than the freezing point of the pre-drying processing liquid on the substrate W. The temperature of the substrate W and the temperature of the pre-drying processing liquid on the substrate W are higher than the temperature of the cold water. The pre-drying processing liquid on the substrate W is thus cooled uniformly via the substrate W. Then, when a predetermined time elapses from the opening of the cooling fluid valve 77, the cooling fluid valve 77 is closed and the discharge of the cold water is stopped.

As shown in FIG. 6, when the pre-drying processing liquid is heated, the saturation concentration of the solidified body forming substance in the pre-drying processing liquid increases and when the pre-drying processing liquid is cooled, the saturation concentration of the solidified body forming substance in the pre-drying processing liquid decreases. FIG. 6 shows an example where the saturation concentration of the solidified body forming substance in the pre-drying processing liquid becomes equal to the concentration of the solidified body forming substance in the pre-drying processing liquid at a time T1. After the time T1, the saturation concentration of the solidified body forming substance in the pre-drying processing liquid falls below the concentration of the solidified body forming substance in the pre-drying processing liquid and crystals containing the solidified body forming substance precipitate. The solidified body 101 (see FIG. 5B), containing the solidified body forming substance, is thereby formed inside the pre-drying processing liquid. The concentration of the solidified body forming substance is increased by the heating of the pre-drying processing liquid and therefore the solidified body 101 is formed in a short time in comparison to a case where the pre-drying processing liquid is not heated.

Further, the pre-drying processing liquid on the substrate W is not cooled directly but is cooled indirectly via the substrate W. The forming of the solidified body 101 that corresponds to a solidified film begins, not from a surface layer of the pre-drying processing liquid on the substrate W, but from a bottom layer 102, which, of the pre-drying processing liquid on the substrate W, is in contact with the upper surface (front surface) of the substrate W. Therefore, immediately after the cooling of the pre-drying processing liquid is started, just the bottom layer 102 of the pre-drying processing liquid on the substrate W is solidified, and at least a portion of the surface layer, which, of the pre-drying processing liquid on the substrate W, is positioned on the bottom layer 102, is not solidified. Therefore, immediately after the solidified body 101 is formed by the cooling of the pre-drying processing liquid, the pre-drying processing liquid is present on the solidified body 101.

A thickness of the solidified body 101 changes in accordance with a plurality of conditions including a cooling temperature of the pre-drying processing liquid, a cooling time of the pre-drying processing liquid, an amount of the pre-drying processing liquid on the substrate W, a thickness of the pre-drying processing liquid on the substrate W, and a concentration of the solidified body forming substance in the pre-drying processing liquid. FIG. 5B shows an example where the solidified body 101 becomes enlarged until the thickness of the solidified body 101 exceeds a height of the patterns P1 and an entirety of the patterns P1 is embedded in the solidified body 101. As long as collapse of the patterns P1 does not occur when excess pre-drying processing liquid is removed from the substrate W, just tip portions of the patterns P1 may project out from the solidified body 101.

After the solidified body 101 is formed inside the pre-drying processing liquid, a liquid removing step (step S10 of FIG. 4) of removing the excess pre-drying processing liquid from the upper surface of the substrate W while letting the solidified body 101 remain on the upper surface of the substrate W as shown in FIG. 5C is performed.

The removal of the pre-drying processing liquid may be performed by discharging nitrogen gas toward the upper surface of the rotating substrate W or may be performed by accelerating the substrate Win a rotation direction. Or, both the discharge of nitrogen gas and the acceleration of the substrate W may be performed. As long as the excess pre-drying processing liquid is removed from the substrate W after the solidified body 101 has been formed by the cooling of the pre-drying processing liquid, the removal of the pre-drying processing liquid may be started before or after the cooling of the pre-drying processing liquid is started or may be started at the same time as starting the cooling of the pre-drying processing liquid.

If the excess pre-drying processing liquid is to be expelled by the discharge of nitrogen gas, the upper gas valve 57 is opened and the central nozzle 55 is made to start the discharge of nitrogen gas in a state where the blocking member 51 is positioned at the lower position. The nitrogen gas discharged downward from the central nozzle 55 flows radially through the space between the upper surface of the substrate W and the lower surface 51L of the blocking member 51. In addition to or in place of the discharge of nitrogen gas from the central nozzle 55, the opening degree of the flow control valve 65 may be changed to increase the flow rate of the nitrogen gas discharged from the upper central opening 61 of the blocking member 51. In either case, the excess pre-drying processing liquid on the substrate W flows outward on the substrate W upon receiving pressure of the radially flowing nitrogen gas. The excess pre-drying processing liquid is thereby removed from the substrate W.

If the excess pre-drying processing liquid is to be expelled by the acceleration of the substrate W, the spin motor 14 increases the rotational speed of the substrate W to a liquid removing speed that is greater than the film thickness decreasing speed and maintains the speed at the liquid removing speed. The excess pre-drying processing liquid on the substrate W receives the centrifugal force generated by the rotation of the substrate W and flows outward on the substrate W. The excess pre-drying processing liquid is thereby removed from the substrate W. Therefore, by performing both the discharge of nitrogen gas and the acceleration of the substrate W, the excess pre-drying processing liquid can be removed rapidly from the substrate W.

Next, a sublimating step (step S11 of FIG. 4) of making the solidified body 101 on the substrate W sublimate to remove it from the upper surface of the substrate W is performed.

Specifically, in the state where the blocking member 51 is positioned at the lower position, the spin motor 14 increases the rotational speed of the substrate W to a sublimating speed that is greater than the liquid removing speed and maintains the speed at the sublimating speed. If the upper gas valve 57 is closed, the upper gas valve 57 is opened to make the central nozzle 55 start the discharge of nitrogen gas. If the upper gas valve 57 is opened, the opening degree of the flow control valve 58 may be changed to increase the flow rate of the nitrogen gas discharged from the central nozzle 55. When a predetermined time elapses from the start of rotation of the substrate W at the sublimating speed, the spin motor 14 stops and the rotation of the substrate W is stopped (step S12 of FIG. 4).

When the rotation of the substrate W at the sublimating speed, etc., are started, the solidified body 101 on the substrate W changes to a gas without transition to a liquid as shown in FIG. 5D. The gas (gas containing the solidified body forming substance) generated from the solidified body 101 flows radially through the space between the substrate W and the blocking member 51 and is expelled from above the substrate W. The solidified body 101 is thereby removed from the upper surface of the substrate W. Further, even if a liquid, such as pure water, etc., is attached to the lower surface of the substrate W before the sublimation of the solidified body 101 is started, the liquid is removed from the substrate W by the rotation of the substrate W. Unnecessary substances, such as the solidified body 101, etc., are thereby removed from the substrate Wand the substrate W is dried. The substrate W is thus dried without forming a liquid surface between two mutually adjacent patterns P1 and therefore a collapse rate of the patterns P1 can be decreased.

Next, a carry-out step (step S13 of FIG. 4) of carrying the substrate W out from the chamber 4 is performed.

Specifically, the blocking member elevating/lowering unit 54 elevates the blocking member 51 to the upper position and the guard elevating/lowering unit 27 lowers all of the guards 24 to the lower positions. Further, the upper gas valve 64 and the lower gas valve 84 are closed and the upper central opening 61 of the blocking member 51 and the lower central opening 81 of the spin base 12 stop the discharge of nitrogen gas. Thereafter, the center robot CR makes the hand H1 enter inside the chamber 4. After the plurality of chuck pins 11 release the gripping of the substrate W, the center robot CR supports the substrate W on the spin chuck 10 with the hand H1. Thereafter, the center robot CR makes the hand H1 retreat from the interior of the chamber 4 while supporting the substrate W with the hand H1. The processed substrate W is thereby carried out from the chamber 4.

Second Processing Example

Next, an example where the pre-drying processing liquid on the substrate W is cooled to not higher than its freezing point to solidify a portion of the pre-drying processing liquid shall be described.

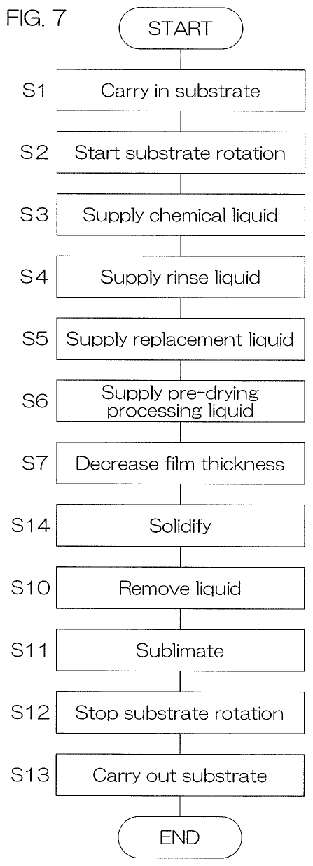

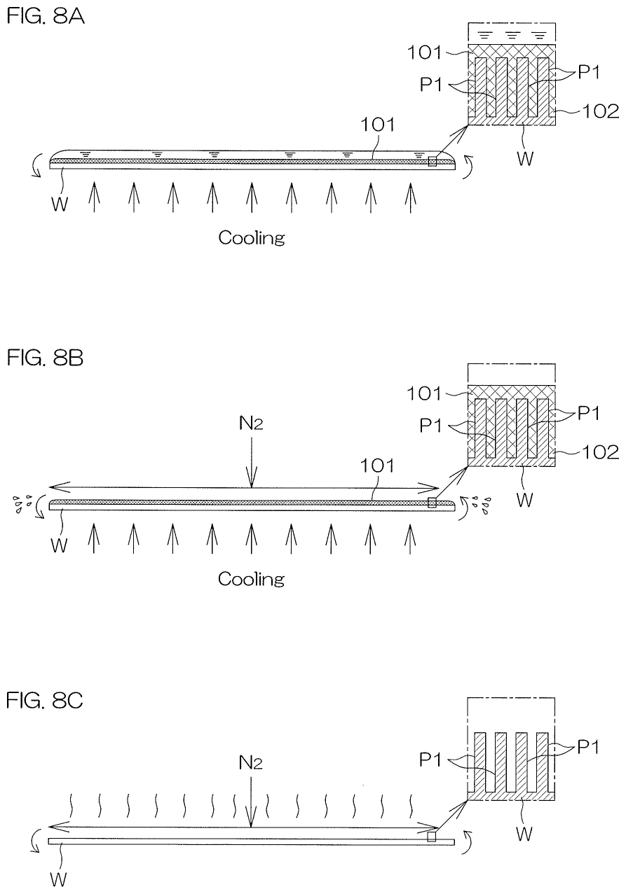

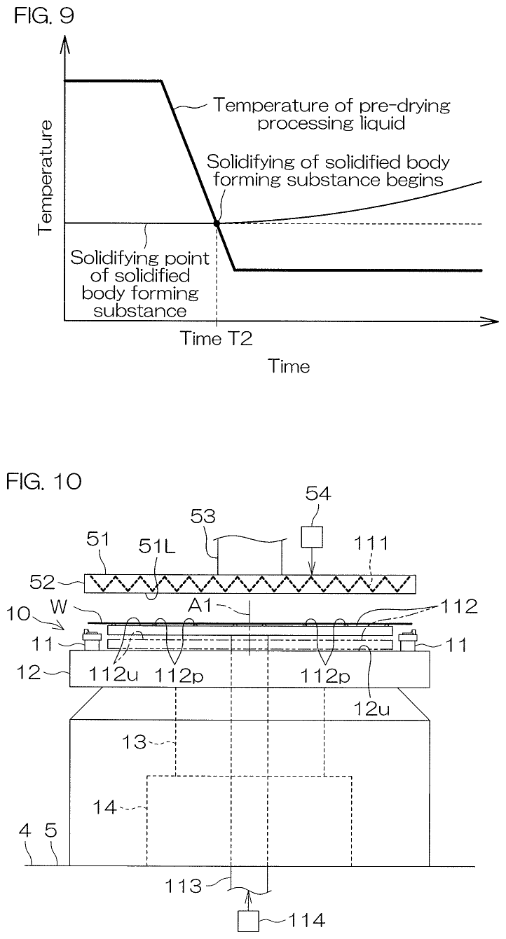

FIG. 7 is a process flowchart for describing an example (second processing example) of processing of the substrate W performed by the substrate processing apparatus 1. FIG. 8A to FIG. 8C are schematic views, each showing a state of the substrate W when the processing of the substrate W shown in FIG. 7 is being performed. FIG. 9 is a graph showing an image of how the freezing point and the temperature of the pre-drying processing liquid on the substrate W change. FIG. 2 and FIG. 7 shall be referenced in the following description. FIG. 8A to FIG. 8C and FIG. 9 shall be referenced where appropriate.

In the following, a flow from a start of a solidifying step to an end of the sublimating step shall be described. Steps besides these are the same as in the first processing example and description thereof shall thus be omitted.

After the film thickness decreasing step (step S7 of FIG. 7) described above has been performed, a solidifying step (step S14 of FIG. 7) of supplying, to the lower surface of the substrate W, cold water of lower temperature than the pre-drying processing liquid on the substrate W to cool the pre-drying processing liquid on the substrate W to not higher than the freezing point of the pre-drying processing liquid is performed.

Specifically, in the state where the blocking member 51 is positioned at the lower position and the substrate W is rotating at the liquid supplying speed after the heating fluid valve 73 is closed, the cooling fluid valve 77 is opened and the lower surface nozzle 71 starts discharge of cold water. The cold water discharged upward from the lower surface nozzle 71 lands on the lower surface central portion of the substrate W and thereafter flows outward along the lower surface of the rotating substrate W. The cold water is thereby supplied to the entirety of the lower surface of the substrate W. The temperature of the cold water is lower than room temperature and the freezing point of the pre-drying processing liquid on the substrate W. The temperature of the substrate W and the temperature of the pre-drying processing liquid on the substrate W are higher than the temperature of the cold water. The pre-drying processing liquid on the substrate W is thus cooled uniformly via the substrate W. Then, when a predetermined time elapses from the opening of the cooling fluid valve 77, the cooling fluid valve 77 is closed and the discharge of the cold water is stopped.

The cooling temperature of the pre-drying processing liquid is lower than the freezing point of the pre-drying processing liquid on the substrate Wand therefore when the cooling of the pre-drying processing liquid is continued, the actual temperature of the pre-drying processing liquid decreases to the freezing point of the pre-drying processing liquid. FIG. 9 shows an example where the actual temperature of the pre-drying processing liquid becomes equal to the freezing point of the pre-drying processing liquid at a time T2. After the time T2, a portion of the pre-drying processing liquid on the substrate W solidifies and the solidified body 101 gradually becomes larger. The concentration of the solidified body forming substance is, for example, not less than a eutectic point concentration of the solidified body forming substance and the dissolution substance. Therefore, when the solidifying of the pre-drying processing liquid begins, the solidified body 101 of the solidified body forming substance or the solidified body 101 having the solidified body forming substance as a main component is formed inside the pre-drying processing liquid. The solidified body 101 that is high in purity of the solidified body forming substance can thereby be formed inside the pre-drying processing liquid.

Further, the pre-drying processing liquid on the substrate W is not cooled directly but is cooled indirectly via the substrate W. The forming of the solidified body 101 begins, not from the surface layer of the pre-drying processing liquid on the substrate W, but from the bottom layer 102, which, of the pre-drying processing liquid on the substrate W, is in contact with the upper surface (front surface) of the substrate W. Therefore, as shown in FIG. 8A, immediately after the cooling of the pre-drying processing liquid is started, just the bottom layer 102 of the pre-drying processing liquid on the substrate W is solidified, and at least a portion of the surface layer, which, of the pre-drying processing liquid on the substrate W, is positioned on the bottom layer 102, is not solidified. Therefore, immediately after the solidified body 101 is formed by the cooling of the pre-drying processing liquid, the pre-drying processing liquid is present on the solidified body 101.

The thickness of the solidified body 101 changes in accordance with the plurality of conditions including the cooling temperature of the pre-drying processing liquid, the cooling time of the pre-drying processing liquid, the amount of the pre-drying processing liquid on the substrate W, the thickness of the pre-drying processing liquid on the substrate W, and the concentration of the solidified body forming substance in the pre-drying processing liquid. FIG. 8A shows an example where the solidified body 101 becomes enlarged until the thickness of the solidified body 101 exceeds the height of the patterns P1 and the entirety of the patterns P1 is embedded in the solidified body 101. As long as collapse of the patterns P1 does not occur when excess pre-drying processing liquid is removed from the substrate W, just the tip portions of the patterns P1 may project out from the solidified body 101.

After the solidified body 101 is formed inside the pre-drying processing liquid, the liquid removing step (step S10 of FIG. 7) of removing the excess pre-drying processing liquid from the upper surface of the substrate W while letting the solidified body 101 remain on the upper surface of the substrate W as shown in FIG. 8B is performed.

The removal of the pre-drying processing liquid may be performed by discharging nitrogen gas toward the upper surface of the rotating substrate W or may be performed by accelerating the substrate W in the rotation direction. Or, both the discharge of nitrogen gas and the acceleration of the substrate W may be performed. As long as the excess pre-drying processing liquid is removed from the substrate W after the solidified body 101 has been formed by the cooling of the pre-drying processing liquid, the removal of the pre-drying processing liquid may be started before or after the cooling of the pre-drying processing liquid is started or may be started at the same time as starting the cooling of the pre-drying processing liquid.

If the excess pre-drying processing liquid is to be expelled by the discharge of nitrogen gas, the upper gas valve 57 is opened and the central nozzle 55 is made to start the discharge of nitrogen gas in the state where the blocking member 51 is positioned at the lower position. The nitrogen gas discharged downward from the central nozzle 55 flows radially through the space between the upper surface of the substrate W and the lower surface 51L of the blocking member 51. In addition to or in place of the discharge of nitrogen gas from the central nozzle 55, the flow rate of the nitrogen gas discharged from the upper central opening 61 of the blocking member 51 may be increased. In either case, the excess pre-drying processing liquid on the substrate W flows outward on the substrate W upon receiving the pressure of the radially flowing nitrogen gas. The excess pre-drying processing liquid is thereby removed from the substrate W.

If the excess pre-drying processing liquid is to be expelled by the acceleration of the substrate W, the spin motor 14 increases the rotational speed of the substrate W to the liquid removing speed that is greater than the film thickness decreasing speed and maintains the speed at the liquid removing speed. The excess pre-drying processing liquid on the substrate W receives the centrifugal force generated by the rotation of the substrate Wand flows outward on the substrate W. The excess pre-drying processing liquid is thereby removed from the substrate W. Therefore, by performing both the discharge of nitrogen gas and the acceleration of the substrate W, the excess pre-drying processing liquid can be removed rapidly from the substrate W.

Next, the sublimating step (step S11 of FIG. 7) of making the solidified body 101 on the substrate W sublimate to remove it from the upper surface of the substrate W is performed.

Specifically, in the state where the blocking member 51 is positioned at the lower position, the spin motor 14 increases the rotational speed of the substrate W to the sublimating speed that is greater than the liquid removing speed and maintains the speed at the sublimating speed. If the upper gas valve 57 is closed, the upper gas valve 57 is opened to make the central nozzle 55 start the discharge of nitrogen gas. If the upper gas valve 57 is opened, the flow rate of the nitrogen gas discharged from the central nozzle 55 maybe increased. When the predetermined time elapses from the start of rotation of the substrate W at the sublimating speed, the spin motor 14 stops and the rotation of the substrate W is stopped (step S12 of FIG. 7).

When the rotation of the substrate W at the sublimating speed, etc., are started, the solidified body 101 on the substrate W changes to a gas without transition to a liquid as shown in FIG. 8C. The gas (gas containing the solidified body forming substance) generated from the solidified body 101 flows radially through the space between the substrate W and the blocking member 51 and is expelled from above the substrate W. The solidified body 101 is thereby removed from the upper surface of the substrate W. Further, even if a liquid, such as pure water, etc., is attached to the lower surface of the substrate W before the sublimation of the solidified body 101 is started, the liquid is removed from the substrate W by the rotation of the substrate W. Unnecessary substances, such as the solidified body 101, etc., are thereby removed from the substrate Wand the substrate W is dried. The substrate W is thus dried without forming a liquid surface between two mutually adjacent patterns P1 and therefore the collapse rate of the patterns P1 can be decreased.

As described above, with the first preferred embodiment, instead of supplying a melt of the solidified body forming substance to the front surface of the substrate W, the pre-drying processing liquid that contains the solidified body forming substance is supplied to the front surface of the substrate W. The pre-drying processing liquid contains the solidified body forming substance that is a substance for forming the solidified body 101 and the dissolution substance that blends together with the solidified body forming substance. That is, the solidified body forming substance and the dissolution substance are mutually blended together and the freezing point of the pre-drying processing liquid is thereby lowered. The freezing point of the pre-drying processing liquid is lower than the freezing point of the solidified body forming substance.

If the pre-drying processing liquid is a liquid at ordinary temperature and ordinary pressure, that is, if the freezing point of the pre-drying processing liquid is lower than room temperature (for example 23° C. or a value in a vicinity thereof) at ordinary pressure (pressure inside a substrate processing apparatus 1; for example, 1 atmosphere or a value in a vicinity thereof), the pre-drying processing liquid does not have to be heated to maintain the pre-drying processing liquid as a liquid. A heater that heats the pre-drying processing liquid thus does not have to be provided. Even if the freezing point of the pre-drying processing liquid is not lower than room temperature at ordinary pressure and heating of the pre-drying processing liquid is necessary to maintain the pre-drying processing liquid as a liquid, an applied heat amount can be decreased in comparison to a case of using the melt of the solidified body forming substance. An energy consumption amount can thereby be decreased.

After the pre-drying processing liquid is supplied to the front surface of the substrate W, a portion of the pre-drying processing liquid on the front surface of the substrate W is solidified. The solidified body 101, containing the solidified body forming substance, is thereby formed inside the pre-drying processing liquid. Thereafter, the remaining pre-drying processing liquid is removed from the front surface of the substrate W. The solidified body 101 thereby remains on the front surface of the substrate W. The solidified body 101 is then changed to a gas. The solidified body 101 is thereby eliminated from the front surface of the substrate W. Therefore, even when the fragile patterns P1 are formed on the front surface of the substrate W, the substrate W can be dried while suppressing pattern collapse because the substrate W is dried without forming a liquid surface between two mutually adjacent patterns P1.

With the first processing example, the pre-drying processing liquid on the front surface of the substrate W is cooled to decrease the saturation concentration of the solidified body forming substance in the pre-drying processing liquid. When the saturation concentration of the solidified body forming substance falls below the concentration of the solidified body forming substance, crystals of the solidified body forming substance or crystals having the solidified body forming substance as a main component precipitate. The solidified body 101 that is high in purity of the solidified body forming substance can thereby be formed inside the pre-drying processing liquid and the solidified body 101 that is high in purity of the solidified body forming substance can be left to remain on the front surface of the substrate W.

With the first processing example, the pre-drying processing liquid on the front surface of the substrate W is heated. A portion of the pre-drying processing liquid thereby evaporates and the pre-drying processing liquid on the substrate W decreases. Thereafter, the pre-drying processing liquid on the front surface of the substrate W is cooled to decrease the saturation concentration of the solidified body forming substance. The solidified body 101 can be formed in a short time in comparison to a case where the pre-drying processing liquid is not heated because the pre-drying processing liquid on the substrate W is decreased by the preheating of the pre-drying processing liquid.

With the first processing example, the vapor pressure of the dissolution substance contained in the pre-drying processing liquid is higher than the vapor pressure of the solidified body forming substance contained in the pre-drying processing liquid. Therefore, when the pre-drying processing liquid is heated before cooling, the dissolution substance evaporates at the evaporation rate (evaporation amount per unit time) higher than the evaporation rate of the solidified body forming substance. The concentration of the solidified body forming substance in the pre-drying processing liquid can thereby be increased. The solidified body 101 can thus be formed in a short time in comparison to a case where the pre-drying processing liquid is not heated.

With the second processing example, the pre-drying processing liquid on the front surface of the substrate W is cooled to not higher than the freezing point of the pre-drying processing liquid. A portion of the pre-drying processing liquid thereby solidifies and the solidified body 101 gradually becomes larger. The concentration of the solidified body forming substance is not less than the eutectic point concentration of the solidified body forming substance and the dissolution substance and therefore when the solidifying of the pre-drying processing liquid begins, the solidified body 101 of the solidified body forming substance or the solidified body 101 having the solidified body forming substance as the main component is formed inside the pre-drying processing liquid. The solidified body 101 that is high in purity of the solidified body forming substance can thereby be formed inside the pre-drying processing liquid.

On the other hand, when the solidifying of the solidified body forming substance progresses due to the cooling of the pre-drying processing liquid, the concentration of the solidified body forming substance in the pre-drying processing liquid gradually decreases. In other words, the concentration of the dissolution substance in the pre-drying processing liquid gradually increases. The pre-drying processing liquid that is increased in the concentration of the dissolution substance is then removed from the substrate W and the solidified body 101 that is high in purity of the solidified body forming substance remains on the substrate W. The solidified body forming substance contained in the pre-drying processing liquid can thus be used efficiently.

With the first and second processing examples, the pre-drying processing liquid on the front surface of the substrate W is cooled indirectly by cooling the substrate W instead of cooling the pre-drying processing liquid on the front surface of the substrate W directly. The bottom layer 102, which, in the pre-drying processing liquid on the front surface of the substrate W, contacts the front surface of the substrate W (which, if the patterns P1 are formed, includes front surfaces of the patterns P1), is thus cooled efficiently and the solidified body 101 is formed at an interface between the pre-drying processing liquid and the substrate W. The excess pre-drying processing liquid remains on the solidified body 101. Therefore, by removing the pre-drying processing liquid from the top of the solidified body 101, the pre-drying processing liquid can be removed from the front surface of the substrate W while letting the solidified body 101 remain on the front surface of the substrate W.

With the first and second processing examples, the pre-drying processing liquid of room temperature is supplied to the substrate W. Whereas the solidifying point of the solidified body forming substance is not lower than room temperature, the solidifying point of the pre-drying processing liquid is lower than room temperature. If the melt of the solidified body forming substance is supplied to the substrate W, the solidified body forming substance must be heated to maintain the solidified body forming substance as a liquid. On the other hand, if the pre-drying processing liquid is supplied to the substrate W, the pre-drying processing liquid can be maintained as a liquid even without heating the pre-drying processing liquid. The energy consumption amount required for processing the substrate W can thereby be decreased.

With the first and second processing examples, before the solidified body 101 is formed inside the pre-drying processing liquid, the substrate W is rotated around the vertical rotational axis A1 while being held horizontally. A portion of the pre-drying processing liquid on the front surface of the substrate W is removed from the substrate W by the centrifugal force. The film thickness of the pre-drying processing liquid is thereby decreased. The solidified body 101 is formed thereafter. The solidified body 101 can be formed in a short time and the solidified body 101 can be made thin because the film thickness of the pre-drying processing liquid is decreased. Time required for forming the solidified body 101 and time required for vaporization of the solidified body 101 can thus be shortened. The energy consumption amount required for processing the substrate W can thereby be decreased.

A second preferred embodiment shall now be described.

Main points of difference of the second preferred embodiment with respect to the first preferred embodiment are that a built-in heater 111 is incorporated in the blocking member 51 and that a cooling plate 112 is provided in place of the lower surface nozzle 71.

FIG. 10 is a schematic view as viewed horizontally of the spin chuck 10 and the blocking member 51 according to the second preferred embodiment of the present invention. In FIG. 10, FIG. 11A, and FIG. 11B, configurations equivalent to the configurations shown in FIG. 1 to FIG. 9 described above are provided with the same reference symbols as in FIG. 1, etc., and description thereof shall be omitted.

As shown in FIG. 10, the built-in heater 111 is disposed in an interior of the disk portion 52 of the blocking member 51. The built-in heater 111 is elevated and lowered together with the blocking member 51. The substrate W is disposed below the built-in heater 111. The built-in heater 111 is, for example, a heating wire that generates heat by being energized. A temperature of the built-in heater 111 is changed by the controller 3. When the controller 3 makes the built-in heater 111 generate heat, an entirety of the substrate W is heated uniformly.

The cooling plate 112 is disposed above the spin base 12. The substrate W is disposed above the cooling plate 112. The plurality of chuck pins 11 are disposed in a periphery of the cooling plate 112. A center line of the cooling plate 112 is disposed on the rotational axis A1 of the substrate W. An outer diameter of the cooling plate 112 is smaller than the diameter of the substrate W. A temperature of the cooling plate 112 is changed by the controller 3. When the controller 3 decreases the temperature of the cooling plate 112, the entirety of the substrate W is cooled uniformly.

The cooling plate 112 is supported horizontally by the support shaft 53 extending downward from a central portion of the cooling plate 112. The cooling plate 112 includes an upper surface 112u that is parallel to the lower surface of the substrate W. The cooling plate 112 may include a plurality of projections 112p projecting upward from the upper surface 112u. The cooling plate 112 is movable up and down with respect to the spin base 12. Even when the spin chuck 10 rotates, the cooling plate 112 does not rotate.

The cooling plate 112 is connected to a plate elevating/lowering unit 114 via the support shaft 53. The plate elevating/lowering unit 114 elevates and lowers the cooling plate 112 vertically between an upper position (position indicated by solid lines in FIG. 10) and a lower position (position indicated by alternate long and two short dashed line in FIG. 10). The upper position is a contacting position, at which the cooling plate 112 contacts the lower surface of the substrate W. The lower position is a proximity position, at which the cooling plate 112 is disposed between the lower surface of the substrate Wand the upper surface 12u of the spin base 12 in a state of being separated from the substrate W.

The plate elevating/lowering unit 114 positions the cooling plate 112 at any position from the upper position to the lower position. When the cooling plate 112 is elevated to the upper position in a state where the substrate W is supported by the plurality of chuck pins 11 and the gripping of the substrate W is released, the plurality of projections 112p of the cooling plate 112 contact the lower surface of the substrate W and the substrate W is supported by the cooling plate 112. The substrate W is thereafter lifted by the cooling plate 112 and is separated upward from the plurality of chuck pins 11. When the cooling plate 112 is lowered to the lower position in this state, the substrate W on the cooling plate 112 is placed on the plurality of chuck pins 11 and the cooling plate 112 separates downward from the substrate W. The substrate W is thereby transferred between the plurality of chuck pins 11 and the cooling plate 112.

FIG. 11A is a schematic view showing a state of the substrate W when the pre-drying processing liquid on the substrate W is heated by the built-in heater 111.

As shown in FIG. 11A, in the preheating step (step S8 of FIG. 4), the temperature of the built-in heater 111 may be raised to a temperature higher than room temperature instead of supplying hot water to the lower surface of the substrate W. If the pre-drying processing liquid on the substrate W is to be heated using both hot water and the built-in heater 111, the built-in heater 111 should be incorporated in the blocking member 51 according to the first preferred embodiment.

If the built-in heater 111 is used, the temperature of the pre-drying processing liquid on the substrate W can be changed, even with the temperature of the built-in heater 111 being the same, by making the blocking member elevating/lowering unit 54 elevate or lower the blocking member 51 to change an interval between the blocking member 51 and the substrate Win the up/down direction. The temperature of the pre-drying processing liquid on the substrate W can thus be adjusted more precisely by adjusting not just the temperature of the built-in heater 111 but also the interval between the blocking member 51 and the substrate W.

FIG. 11B is a schematic view showing a state of the substrate W when the pre-drying processing liquid on the substrate W is cooled by the cooling plate 112.

As shown in FIG. 11B, in at least one of the precipitating step (step S9 of FIG. 4) and the solidifying step (step S14 of FIG. 7), the temperature of the cooling plate 112 may be decreased to a temperature lower than room temperature instead of supplying the cold water to the lower surface of the substrate W. In this case, the cooling plate 112 may be made to contact the lower surface of the substrate W or may be put in proximity to the lower surface of the substrate W. That is, the cooling plate 112 may be disposed at any position from the upper position to the lower position. As with the built-in heater 111 incorporated in the blocking member 51, the temperature of the pre-drying processing liquid on the substrate W can be adjusted more precisely by adjusting not just the temperature of the cooling plate 112 but also an interval between the cooling plate 112 and the substrate W.

With the second preferred embodiment, the following actions and effects can be exhibited in addition to the actions and effects according to the first preferred embodiment. Specifically, with the second preferred embodiment, the cooling plate 112, which is an example of a cooling member of lower temperature than the pre-drying processing liquid on the front surface of the substrate W is disposed at the rear surface side of the substrate W, which is a flat surface opposite the front surface of the substrate W. If the cooling plate 112 is made to contact the rear surface of the substrate W, the substrate W is cooled directly by the cooling member. If the cooling plate 112 is put in proximity to the rear surface of the substrate W without letting it contact the rear surface of the substrate W, the substrate W is cooled indirectly by the cooling member. Therefore, in either case, the pre-drying processing liquid on the front surface of the substrate W can be cooled indirectly without making a fluid contact the substrate W.

A third preferred embodiment shall now be described.

Main points of difference of the third preferred embodiment with respect to the first preferred embodiment are that a solid removing step of changing the solidified body 101 to a gas without transition to a liquid is not a sublimating step but is a plasma irradiating step of irradiating plasma onto the substrate W and that the plasma irradiating step is performed in a different processing unit 2.

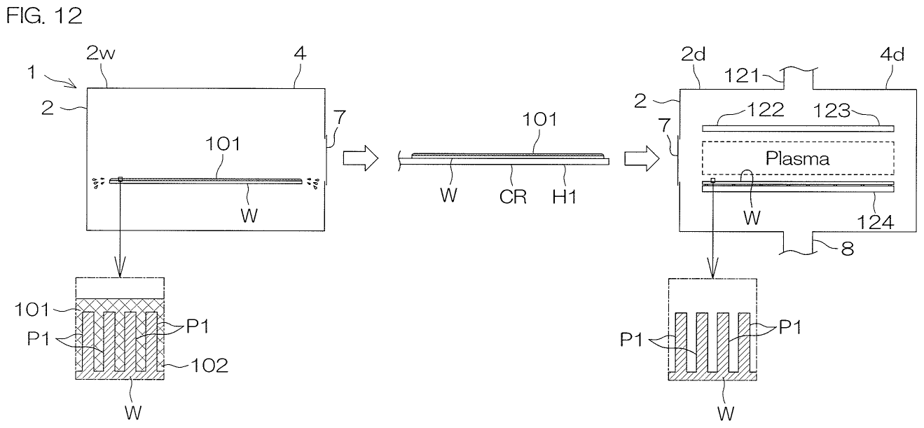

FIG. 12 is a schematic view for describing transfer of the substrate W from the wet processing unit 2w, which removes the excess pre-drying processing liquid, to a dry processing unit 2d, which changes the solidified body 101 to a gas without transition to a liquid. In FIG. 12, configurations equivalent to the configurations shown in FIG. 1 to FIG. 11B described above are provided with the same reference symbols as in FIG. 1, etc., and description thereof shall be omitted.

The plurality of processing units 2 provided in the substrate processing apparatus 1 include, in addition to the wet processing unit 2w, which supplies processing liquids to the substrate W, the dry processing unit 2d, which processes the substrate W without supplying a processing liquid to the substrate W. FIG. 12 shows an example where the dry processing unit 2d includes a processing gas piping 121, guiding a processing gas into a chamber 4d, and a plasma generator 122, changing the processing gas inside the chamber 4d to plasma. The plasma generator 122 includes an upper electrode 123, disposed above the substrate W, and a lower electrode 124, disposed below the substrate W.

The steps from the carry-in step (step S1 of FIG. 4) to the liquid removing step (step S10 of FIG. 4) shown in FIG. 4 or the steps from the carry-in step (step S1 of FIG. 7) to the liquid removing step (step S10 of FIG. 7) shown in FIG. 7 are performed inside the chamber 4 of the wet processing unit 2w. Thereafter, as shown in FIG. 12, the substrate W is carried out from the chamber 4 of the wet processing unit 2w and carried into the chamber 4d of the dry processing unit 2d by the center robot CR. By a chemical reaction (for example, oxidation by ozone gas) and physical reaction due to the plasma inside the chamber 4d, the solidified body 101 remaining on the front surface of the substrate W changes to a gas without transition to a liquid. The solidified body 101 is thereby eliminated from the substrate W.

With the third preferred embodiment, the following actions and effects can be exhibited in addition to the actions and effects according to the first preferred embodiment. Specifically, with the third preferred embodiment, when the substrate W is disposed inside the chamber 4 of the wet processing unit 2w, the pre-drying processing liquid on the front surface of the substrate W is removed while letting the solidified body 101 remain on the front surface of the substrate W. Thereafter, the substrate W is transferred from the chamber 4 of the wet processing unit 2w to the chamber 4d of the dry processing unit 2d. Then, when the substrate W is disposed inside the chamber 4d of the dry processing unit 2d, the solidified body 101 remaining on the front surface of the substrate W is vaporized. The removing of the pre-drying processing liquid and the removing of the solidified body 101 are thus performed in the chamber 4 and the chamber 4d, respectively, and therefore structures inside the chamber 4 and the chamber 4d can be simplified and chamber 4 and the chamber 4d can be made compact.

Other Preferred Embodiments

The present invention is not restricted to the contents of the preferred embodiments described above and various modifications are possible.

For example, in at least one of the first processing example and the second processing example, a temperature holding step of maintaining the pre-drying processing liquid on the substrate W at a liquid maintaining temperature, higher than the freezing point of the pre-drying processing liquid and lower than a boiling point of the pre-drying processing liquid, to maintain the pre-drying processing liquid on the substrate W as a liquid may be performed.

If a difference between the freezing point of the pre-drying processing liquid and room temperature is small, the solidified body 101 may form inside the pre-drying processing liquid before the pre-drying processing liquid on the substrate W is cooled intentionally. To prevent such unintended forming of the solidified body 101, the temperature holding step may be performed in a period from a start of supplying of the pre-drying processing liquid to the substrate W to a start of cooling of the pre-drying processing liquid on the substrate W. For example, heated nitrogen gas may be discharged toward the upper surface or the lower surface of the substrate W or a heating liquid, such as hot water, etc., may be discharged toward the lower surface of the substrate W.

If pure water or other rinse liquid on the substrate W can be replaced by the pre-drying processing liquid, the pre-drying processing liquid supplying step may be performed without performing the replacing liquid supplying step of replacing the rinse liquid on the substrate W with the replacement liquid.

In the preheating step, a heating gas of higher temperature than the pre-drying processing liquid on the substrate W may be discharged toward the upper surface or the lower surface of the substrate W instead of making hot water, which is an example of the heating liquid, contact the lower surface of the substrate W. For example, heated nitrogen gas maybe discharged toward the upper surface or the lower surface of the substrate W. Both the discharge of heating liquid and the discharge of heating gas may be performed.

In the second preferred embodiment, a hot plate, which is an example of a heating member, may be provided in place of the cooling plate 112, which is an example of the cooling member. In this case, when performing the preheating step, the hot plate may be made to generate heat and meanwhile made to contact the lower surface of the substrate W or the hot plate may be made to generate heat and meanwhile disposed between the lower surface of the substrate W and the upper surface 12u of the spin base 12 without being made to contact the lower surface of the substrate W.

The substrate processing apparatus 1 may include a heating lamp that irradiates light toward the upper surface of the substrate W held by the spin chuck 10. In this case, the heating lamp should be made to irradiate light when performing the preheating step.

The heating lamp may be an overall irradiation lamp that irradiates light toward the entirety of the upper surface of the substrate W simultaneously or may be a partial irradiation lamp that irradiates light toward just an irradiation region that represents a region of a portion within the upper surface of the substrate W. In the latter case, the substrate processing apparatus 1 should be provided with a lamp moving unit that moves the partial irradiation lamp to move the irradiation region within the upper surface of the substrate W.

In at least one of the precipitating step (step S9 of FIG. 4) and the solidifying step (step S14 of FIG. 7), a cooling gas of lower temperature than the pre-drying processing liquid on the substrate W may be discharged toward the upper surface or the lower surface of the substrate W instead of making cold water, which is an example of a cooling liquid, contact the lower surface of the substrate W. For example, cooled nitrogen gas maybe discharged toward the upper surface or the lower surface of the substrate W. Both the discharge of cooling liquid and the discharge of cooling gas may be performed.

The liquid removing step (step S10 of FIG. 4 and step S10 of FIG. 7) may be an evaporating step of making the excess pre-drying processing liquid evaporate by heating the pre-drying processing liquid on the substrate W at a temperature at which the solidified body 101 inside the pre-drying processing liquid does not return to being a liquid.

For example, heated nitrogen gas maybe discharged toward the upper surface of the substrate W. In this case, the excess pre-drying processing liquid is not only removed from the substrate W by the pressure of the nitrogen gas that flows radially along the upper surface of the substrate W but is also removed from the substrate W by evaporation due to heating. The excess pre-drying processing liquid can thus be removed in a shorter time. In addition to the discharge of heated nitrogen gas, the substrate W may be accelerated in the rotation direction to further promote the removal of the excess pre-drying processing liquid.

The preheating step (step S8 of FIG. 4) or the solidifying step (step S14 of FIG. 7) maybe performed without performing the film thickness decreasing step (step S7 of FIG. 4 and FIG. 7) of decreasing the film thickness of the pre-drying processing liquid on the substrate W after the pre-drying processing liquid supplying step (step S6 of FIG. 4).

The blocking member 51 may include, in addition to the disk portion 52, a cylindrical portion, extending downward from an outer peripheral portion of the disk portion 52. In this case, when the blocking member 51 is disposed at the lower position, the substrate W held by the spin chuck 10 is surrounded by the circular cylindrical portion 25.

The blocking member 51 may rotate together with the spin chuck 10 around the rotational axis A1. For example, the blocking member 51 may be placed on the spin base 12 such as not to contact the substrate W. In this case, the blocking member 51 is coupled to the spin base 12 and therefore the blocking member 51 rotates in the same direction and at the same speed as the spin base 12.

The blocking member 51 may be omitted. However, if cold water is to be supplied to the lower surface of the substrate W to cool the pre-drying processing liquid on the substrate W, it is preferable for the blocking member 51 to be provided. This is because droplets of liquid flowing around from the lower surface of the substrate W to the upper surface of the substrate W along the outer peripheral surface of the substrate Wand liquid droplets splashing back inward from the processing cup 21 can be blocked by the blocking member 51 and cold water that becomes mixed in the pre-drying processing liquid on the substrate W can be decreased.

The dry processing unit 2d according to the third preferred embodiment may be included in a substrate processing apparatus differing from the substrate processing apparatus 1 that includes the wet processing unit 2w. That is, the substrate processing apparatus 1 that includes the wet processing unit 2w and the substrate processing apparatus that includes the dry processing unit 2d may be provided in the same substrate processing system and the substrate W, from which the excess pre-drying processing liquid has been removed, may be transferred from the substrate processing apparatus 1 that includes the wet processing unit 2w to the substrate processing apparatus that includes the dry processing unit 2d.

The substrate processing apparatus 1 is not restricted to an apparatus that processes substrates W of disk shape and may instead be an apparatus that processes substrates W of polygonal shape.

The substrate processing apparatus 1 is not restricted to a single substrate processing type apparatus and may instead be a batch type apparatus that processes a plurality of substrates W in a batch.

Two or more of all of the configurations described above may be combined. Two or more of all of the steps described above may be combined.

The pre-drying processing liquid nozzle 39 is an example of a pre-drying processing liquid supplying means. Each of the lower surface nozzle 71 and the cooling plate 112 is an example of a solidified body forming means. Each of the central nozzle 55 and the spin motor 14 is an example of a liquid removing means. Each of the central nozzle 55 and the spin motor 14 is an example of a solid removing means.

While preferred embodiments of the present invention have been described in detail above, these are merely specific examples used to clarify the technical contents of the present invention, and the present invention should not be interpreted as being limited only to these specific examples, and the scope of the present invention shall be limited only by the appended claims.

What is claimed is:

1. A substrate processing method comprising:
a pre-drying processing liquid supplying step of supplying, to a front surface of a substrate, a pre-drying processing liquid, containing a solidified body forming substance, which is a substance for forming a solidified body, and a dissolution substance, which blends together with the solidified body forming substance, and having a freezing point lower than a freezing point of the solidified body forming substance;
a solidified body forming step of solidifying a portion of the pre-drying processing liquid on the front surface of the substrate to form the solidified body, containing the solidified body forming substance, inside the pre-drying processing liquid;
a liquid removing step of removing the pre-drying processing liquid on the front surface of the substrate while letting the solidified body remain on the front surface of the substrate; and
a solid removing step of removing the solidified body, remaining on the front surface of the substrate, from the front surface of the substrate by making the solidified body change to a gas.

2. The substrate processing method according to claim 1, wherein the solidified body forming step includes a cooling step of cooling the pre-drying processing liquid on the front surface of the substrate.

3. The substrate processing method according to claim 2, wherein the cooling step includes a precipitating step of cooling the pre-drying processing liquid on the front surface of the substrate to decrease a saturation concentration of the solidified body forming substance in the pre-drying processing liquid on the front surface of the substrate to a value lower than a concentration of the solidified body forming substance in the pre-drying processing liquid on the front surface of the substrate.

4. The substrate processing method according to claim 3, further comprising: a preheating step of making a portion of the pre-drying processing liquid on the front surface of the substrate evaporate by heating before the pre-drying processing liquid on the front surface of the substrate is cooled.

5. The substrate processing method according to claim 4, wherein a vapor pressure of the dissolution substance is higher than a vapor pressure of the solidified body forming substance.

6. The substrate processing method according to claim 2, wherein a concentration of the solidified body forming substance in the pre-drying processing liquid is not less than a eutectic point concentration of the solidified body forming substance and the dissolution substance in the pre-drying processing liquid, and
the cooling step includes a solidifying step of cooling the pre-drying processing liquid on the front surface of the substrate to not higher than the freezing point of the pre-drying processing liquid.

7. The substrate processing method according to claim 2, wherein the cooling step includes an indirect cooling step of cooling the pre-drying processing liquid on the front surface of the substrate via the substrate to form the solidified body in a bottom layer, which, in the pre-drying processing liquid, contacts the front surface of the substrate, and
the liquid removing step includes a step of removing the pre-drying processing liquid on the solidified body while letting the solidified body remain on the front surface of the substrate.

8. The substrate processing method according to claim 7, wherein the indirect cooling step includes a cooling fluid supplying step of supplying, to a rear surface of the substrate, a cooling fluid, which is a fluid of lower temperature than the pre-drying processing liquid on the front surface of the substrate, in a state where the pre-drying processing liquid is on the front surface of the substrate.

9. The substrate processing method according to claim 7, wherein the indirect cooling step includes a cooling member disposing step of disposing, at the rear surface side of the substrate, a cooling member of lower temperature than the pre-drying processing liquid on the front surface of the substrate.

10. The substrate processing method according to claim 1, wherein the liquid removing step includes a substrate rotating/holding step of rotating the substrate around a vertical rotational axis while holding it horizontally to remove the pre-drying processing liquid on the front surface of the substrate while letting the solidified body remain on the front surface of the substrate.

11. The substrate processing method according to claim 1, wherein the liquid removing step includes a gas supplying step of discharging a gas toward the front surface of the substrate to remove the pre-drying processing liquid on the front surface of the substrate while letting the solidified body remain on the front surface of the substrate.

12. The substrate processing method according to claim 1, wherein the liquid removing step includes an evaporating step of making the pre-drying processing liquid on the front surface of the substrate evaporate by heating to remove the pre-drying processing liquid on the front surface of the substrate while letting the solidified body remain on the front surface of the substrate.

13. The substrate processing method according to claim 1, wherein the freezing point of the solidified body forming substance is not lower than room temperature,
the freezing point of the pre-drying processing liquid is lower than room temperature, and
the pre-drying processing liquid supplying step includes a step of supplying the pre-drying processing liquid of room temperature to the front surface of the substrate.

14. The substrate processing method according to claim 1, further comprising: a film thickness decreasing step of rotating the substrate around a vertical rotational axis while holding it horizontally before the solidified body is formed to remove a portion of the pre-drying processing liquid on the front surface of the substrate by a centrifugal force and decrease a film thickness of the pre-drying processing liquid.

15. The substrate processing method according to claim 1, wherein the solid removing step includes at least one of a sublimating step of making the solidified body sublimate from a solid to a gas,
a decomposition step of making the solidified body change to a gas, without transition to a liquid, by decomposition of the solidified body, and
a reaction step of making the solidified body change to a gas, without transition to a liquid, by a reaction of the solidified body.

16. The substrate processing method according to any of claim 1, further comprising: a substrate transfer step of transferring the substrate, with the solidified body remaining on the front surface of the substrate, from a first chamber, in which the liquid removing step is performed, to a second chamber, in which the solid removing step is performed.

17. A substrate processing apparatus comprising:
a pre-drying processing liquid supplying means, supplying, to a front surface of a substrate, a pre-drying processing liquid, containing a solidified body forming substance, which is a substance for forming a solidified body, and a dissolution substance, which blends together with the solidified body forming substance, and having a freezing point lower than a freezing point of the solidified body forming substance;
a solidified body forming means, solidifying a portion of the pre-drying processing liquid on the front surface of the substrate to form the solidified body, containing the solidified body forming substance, inside the pre-drying processing liquid;
a liquid removing means, removing the pre-drying processing liquid on the front surface of the substrate while letting the solidified body remain on the front surface of the substrate; and
a solid removing means, removing the solidified body, remaining on the front surface of the substrate, from the front surface of the substrate by making the solidified body change to a gas.
